(19) United States
(12) Patent Application Publication
(10) Pub. No.: US 2016/0342932 A1
(43) Pub. Date: Nov. 24, 2016

(54) COLLECTIVE DELIVERY SYSTEM, PROGRAM, AND COLLECTIVE DELIVERY METHOD

(71) Applicant: RAKUTEN, INC., Tokyo (JP)

(72) Inventors: Shinichi IMAEDA, Tokyo (JP); Ryusuke SHINAGAWA, Tokyo (JP); Kenta NAGAZUMI, Tokyo (JP)

(21) Appl. No.: 15/113,838

(22) PCT Filed: Jan. 23, 2014
(86) PCT No.: PCT/JP2014/051406

§ 371 Date: Jul. 25, 2016

(51) Int. Cl. G06Q 10/08

(52) U.S. Cl. CPC G06Q 10/083

(57) ABSTRACT

To reduce a trouble for a user to receive packages when delivery companies that collect the packages from respective shipping sources are different. A collective delivery system (10) is a system for delivering a plurality of packages collected by a plurality of different delivery companies from one or more shipping sources to a single predetermined delivery destination. A first delivery control unit (10C) is able to set first delivery information to be associated with each of the packages such that the package is delivered from the shipping source thereof to a predetermined place different from the single delivery destination. A second delivery control unit (10D) is able to set second delivery information to be associated with each of the packages such that a single delivery company collectively delivers from the predetermined place to the single delivery destination. The first delivery control means (10C) changes the delivery destination included in the first delivery information from the single delivery destination to the predetermined place.

### TECHNICAL FIELD

The present invention relates to a collective delivery system, a program, and a collective delivery method.

### BACKGROUND ART

Conventionally, when a plurality of packages are delivered to a user, the user is bothered to receive the packages at the number of times same as the number of packages. Patent Literature 1 describes a system for having a specific delivery company, when the specific delivery company delivers a plurality of packages to a user, to collectively deliver the plurality of packages to the user. Patent Literature 2 describes a system for setting the same date and time for delivery with respect to all packages so that the packages can be all received in a specific time range. Patent Literature 3 describes a system for setting, in a case where a user orders an item while designating a delivery date and time, a delivery date and time same as the designated delivery date and time with respect to other items having been ordered.

### CITATION LIST

### Patent Literature

Patent Literature 1: JP2002-042005A
Patent Literature 2: JP2012-137983A
Patent Literature 3: JP2013-114392A

### SUMMARY OF INVENTION

### Technical Problem

According to the technique described in Patent Literature 1, however, although a user can collectively receive the packages if a single delivery company handles all packages, a user is bothered to receive the packages at the number of times same as the number of delivery companies when different delivery companies collect the packages from respective shipping sources. Moreover, bad influence of exhaust gas from delivery vehicles is a concern. Similarly, according to the techniques described in Patent Literatures 2 and 3, even though the delivery date and time of respective packages are set to the same date and time, in actuality, respective delivery companies may separately visit the user as the delivery date and time is designated with a margin of a few hours. Naturally, the user is bothered to receive at the same number of times as the number of delivery companies.

The present invention has been conceived in view of the above, and aims to provide a collective delivery system, a program, and a collective delivery method for reducing trouble for a user to receive packages when delivery companies that collect the packages from respective shipping sources are different.

### Solution to Problem

In order to achieve the above described object, a collective delivery system according to the present invention is a system for delivering a plurality of packages collected from one or more shipping sources by a plurality of different delivery companies to a predetermined single delivery destination, including a first delivery control unit capable of setting first delivery information to be associated with each of the plurality of packages such that each of the plurality of different delivery companies delivers from a shipping source thereof to a predetermined place different from the single delivery destination; and a second delivery control unit capable of setting second delivery information to be associated with each of the plurality of packages such that a single delivery company collectively delivers from the predetermined place to the single delivery destination, wherein the first delivery control unit changes a delivery destination included in the first delivery information from the single delivery destination to the predetermined place.

### BRIEF DESCRIPTION OF DRAWINGS

FIG. 1 shows one example of a collective delivery system according to an embodiment of the present invention;

FIG. 2 shows an outline of processing executed by a collective delivery system;

FIG. 3 is a function block diagram showing one example of functions implemented in this embodiment;

FIG. 4 shows one example of a menu screen displayed when authentication is successfully completed;

FIG. 5 shows one example of a designation screen for a user to designate a collective delivery condition;

FIG. 6 shows one example of order information;

FIG. 7 shows an example of data included in setting information;

FIG. 8 shows an example of data included in first delivery information;

FIG. 9 shows one example of a sales voucher printed at a store;

FIG. 10 shows an example of data included in second delivery information;

FIG. 11 shows one example of a sales voucher printed at a holding center;

FIG. 12 shows processing for a user to register collective delivery condition;

FIG. 13 shows processing for delivering a package to a holding center;

FIG. 14 shows processing for delivering a package to a place of a user, etc.;

FIG. 15 shows an outline of processing executed by a collective delivery system;

FIG. 16 shows processing executed by an electronic commerce system;

FIG. 17 shows one example of an order confirmation screen;

FIG. 18 shows a structure of a system according to a second embodiment;

FIG. 19 shows an outline of processing executed by a collective delivery system;

FIG. 20 is a function block diagram showing one example of functions implemented in this embodiment;

FIG. 21 shows one example of order information;

FIG. 22 shows one example of a menu screen displayed upon successful completion of authentication;

FIG. 23 explains processing executed by a first delivery control unit;

FIG. 24 explains processing executed by a second delivery control unit;

FIG. 25 shows one example of a screen for inquiring whether or not to make collective delivery;

FIG. 26 shows one example of an inquiry screen when a list is displayed;

FIG. 27 shows processing executed in the second embodiment;

FIG. 28 shows processing executed in the second embodiment;

FIG. 29 is a function block diagram of a modified example;

FIG. 30 shows shift of screens displayed when a user orders an item;

FIG. 31 explains an outline of processing in a modified example;

FIG. 32 explains an outline of processing in a modified example;

FIG. 33 explains an outline of processing in a modified example;

FIG. 34 shows one example of a screen for inquiring whether or not to make shipment with only packages having been delivered to a holding center;

FIG. 35 shows processing executed in a modified example (3);

FIG. 36 shows one example of a screen for notifying that shipment will be made with only packages having been delivered to a holding center;

FIG. 37 shows one example of a notice screen;

FIG. 38 shows one example of a screen displayed at the time of requesting consolidation or ordering an item; and

FIG. 39 shows one example of a screen for confirming a delivery date and time and a delivery company after requesting consolidation.

### DESCRIPTION OF EMBODIMENTS

### 1. First Embodiment

In the following, an example of an embodiment of the present invention will be described in detail with reference to the drawings.

### [1-1. Overall Structure of Collective Delivery System]

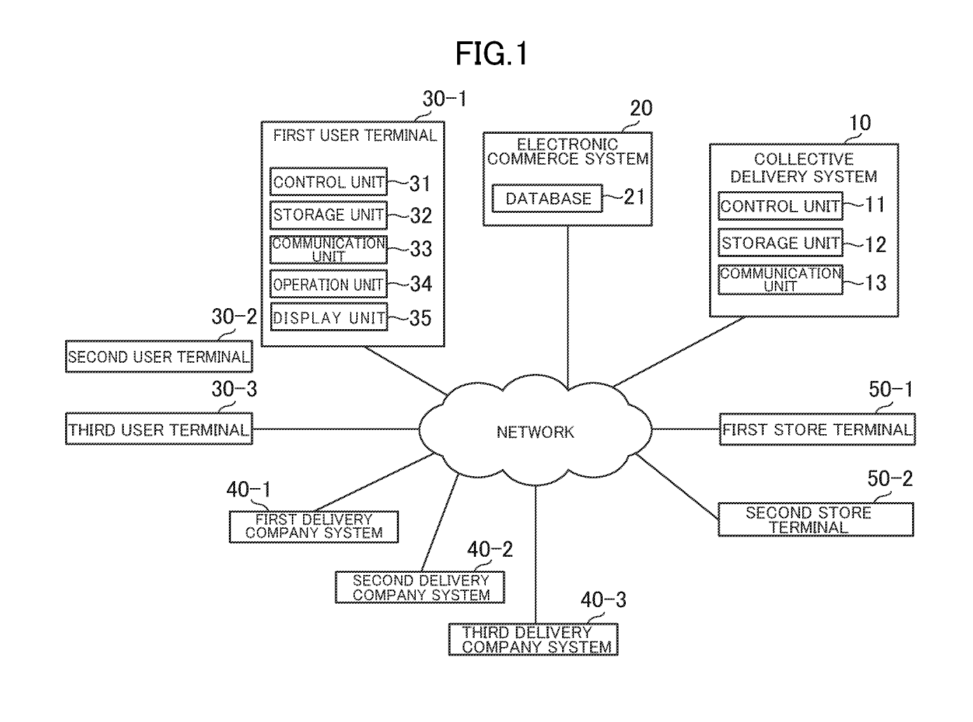

FIG. 1 shows one example of a collective delivery system according to an embodiment of the present invention. As shown in FIG. 1, in this embodiment, a collective delivery system 10, an electronic commerce system 20, first to third user terminals 30-1 to 30-3, first to third delivery company systems 40-1 to 40-3, and first and second store terminals 50-1 and 50-2 are respectively connected to a network such as the Internet or the like.

The collective delivery system 10 includes a typical server computer, and also includes a control unit 11, a storage unit 12, and a communication unit 13. The control unit 11 includes one or more microprocessors, for example. The storage unit 12 includes a main storage unit, such as a RAM or the like, an auxiliary storage unit such as a hard disk or the like. The control unit 11 executes processing according to a program and data stored in the storage unit 12. The communication unit 13 includes a network card, and can send and receive data with respect to the outside via a network.

The electronic commerce system 20 includes a typical server computer, and manages a plurality of stores that sell items. A delivery company that collects an item ordered by a user is decided on at the time of order. A delivery destination of an item may be designated by a user at the time of order or determined by the electronic commerce system 20 by selecting from among the delivery destinations registered in advance by a user. The electronic commerce system 20 includes a database 21 in which order information to be described later is stored.

Each of the first to third user terminals 30-1 to 30-3 is a computer for operation by a user, being, for example, a portable phone, a personal computer, or the like. Each of the first to third user terminals 30-1 to 30-3 includes a control unit 31, a storage unit 32, a communication unit 33, an operation unit 34, and a display unit 35. The hardware structures of the control unit 31, the storage unit 32, and the communication unit 33 are substantially the same as those of the control unit 11, the storage unit 12, and the communication unit 13, respectively, and thus are not described here. The operation unit 34 is an input device for operation by a user. The display unit 35 is a monitor for displaying various screen images.

Each of the first to third delivery company systems 40-1 to 40-3 includes a typical server computer, and integrally manages delivery of a package by a delivery company. In this embodiment, there are a plurality of electronic commerce systems 20 and a plurality of delivery companies affiliated with stores managed by the respective electronic commerce systems 20, and there is a delivery company system available for every delivery company.

Each of the first and second store terminals 50-1 and 50-2 is a computer for operation by a staff from each store in the electronic commerce system 20. Each of the first and second store terminals 50-1 and 50-2 receives content of an order made by a user from the electronic commerce system 20. A printer is connected to each of the first and second store terminals 50-1 and 50-2, so that each of the first and second store terminals 50-1 and 50-2 accesses the first delivery company system 40-1 or the like to print a sales voucher for a package.

Note that as a typical hardware can be employed for each of the above described systems and terminals, a hardware structure of each system and each terminal is not limited to the above described example. Also, a program and data to be described as being stored in each system or terminal may be stored in a computer readable information storage medium (for example, a memory card) and supplied, or may be supplied via a network.

The collective delivery system 10 is a system for delivering a plurality of packages collected from one or more shipping sources by a plurality of different delivery companies to a single predetermined delivery destination. In this embodiment, processing executed by the collective delivery system 10 will be described while referring as an example to delivery that is made when a plurality of users have ordered items for another user. Also, assume here that the collective delivery system 10, the electronic commerce system 20, and the first to third delivery company systems 40-1 to 40-3 are managed by different entities (for example, an operating company) and these are separate systems. However, data is shared between the collective delivery system 10 and the first to third respective delivery company systems 40-1 to 40-3.

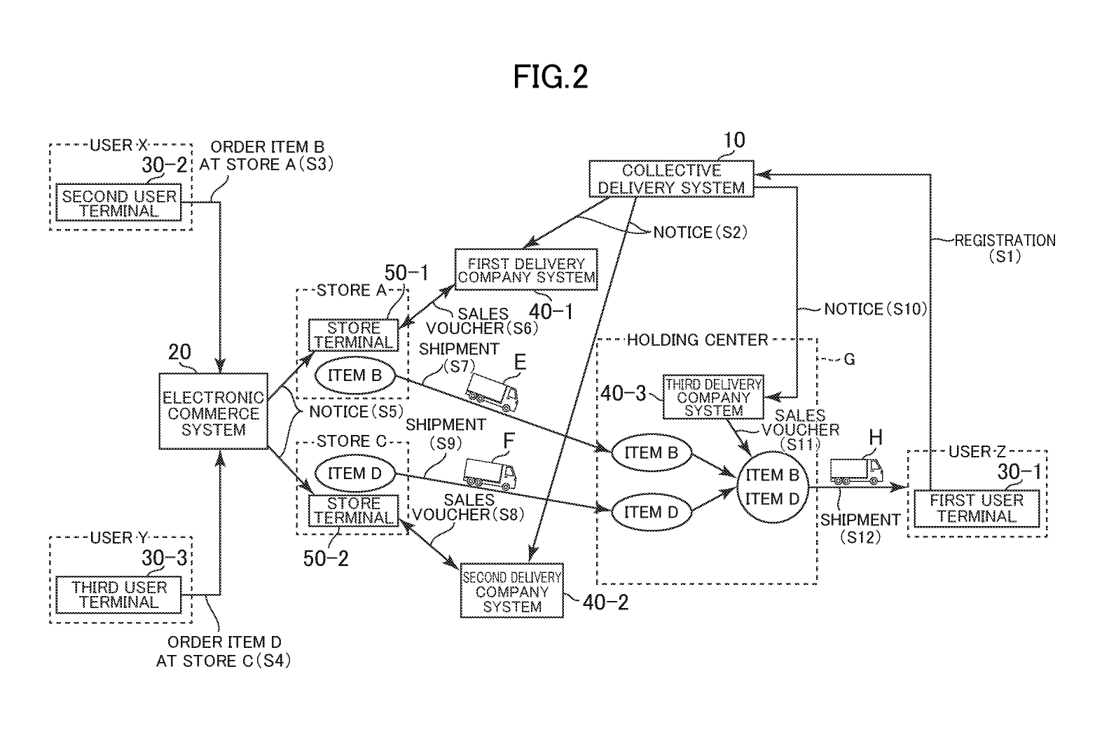

FIG. 2 shows an outline of the processing executed by the collective delivery system 10. As shown in FIG. 2, a user Z (a user who receives an item) registers in the collective delivery system 10 its desired date and time etc. for delivery of a package by operating the first user terminal 30-1 (S1). Having received the registration by the user Z, the collective delivery system 10 notifies the first delivery company system 40-1 and the second delivery company system 40-2 that the user Z wishes collective delivery (S2). With the above, a package addressed to the user Z makes a collective delivery target, and the delivery destination of a package to be shipped from a store is set to a holding center G, to be described later, rather than the place of the user Z etc.

Meanwhile, a user X (a user who orders an item) orders an item B at a store A for the user Z by operating the second user terminal 30-2 (S3). Further, a user Y (a user who orders an item) as well orders an item D at a store C for the user Z by operating the third user terminal 30-3 (S4). The electronic commerce system 20 notifies the store A of the content of the order received from the user X and the store C of the content of the order received from the user Y (S5).

Assume here that the store A is affiliated with a delivery company E, and the store C is affiliated with a delivery company F. Therefore, conventionally, these two delivery companies E and F separately visit the user Z, and resultantly, the user Z is bothered twice to receive the packages. According to this embodiment, however, the holding center G is available for use by the delivery companies E and F so that the user Z can receive all packages at one time. The holding center G may be managed by the delivery company E or F, any other delivery company, or a management company, or the like.

When a staff from the store A accesses the first delivery company system 40-1 by operating the store terminal 50-1 and inputs information to output a sales voucher for the item B, a sales voucher showing the holding center G, instead of the place of the user Z etc., set as the delivery destination of the item B is outputted (S6). Then, the staff from the store A packs the item B and attaches the sales voucher, and the delivery company E collects the item B from the store A (S7). The delivery company E delivers the item B collected from the store A to the holding center G. The item B delivered to the holding center G is temporarily stored in a space allocated to the user Z in the holding center G.

Meanwhile, when a staff from the store C accesses the second delivery company system 40-2 by operating the store terminal 50-2 and inputs information to output a sales voucher for the item D, a sales voucher showing the holding center G, instead of the place of the user Z etc., set as the delivery destination of the item D is outputted (S8). Then, the staff from the store C packs the item D and attaches the sales voucher, and the delivery company F collects the item D from the store C (S9). The delivery company F delivers the item D collected from the store B to the holding center G. The item D delivered to the holding center G is temporarily stored in the space allocated to the user Z in the holding center G.

Meanwhile, the collective delivery system 10 instructs the third delivery company system 40-3 to deliver the packages held in the holding center G to the place of the user Z (S10). This instruction may be made at the time of registration of the delivery date and time etc. by the user Z or every arrival of timing determined based on the date and time registered.

The third delivery company system 40-3 prints a sales voucher for collective delivery of the items B and D having been delivered to the holding center G at the date and time designated by the user Z (S11). A delivery company H for delivery to the place of the user Z (the delivery company E or F or any other will do) collectively delivers the items B and D from the holding center G to the user Z, following the sales voucher (S12).

As described above, in this embodiment, even though the delivery company E that collects the item B from the store A is different from the delivery company F that collects the item D from the store C, it is possible to complete receiving of both the items B and D at one time as the items B and D are once gathered in the holding center G and then delivered by the delivery company H to the place of the user Z. Below, details of this technique will be described.

[1-2. Functions Implemented in this Embodiment]

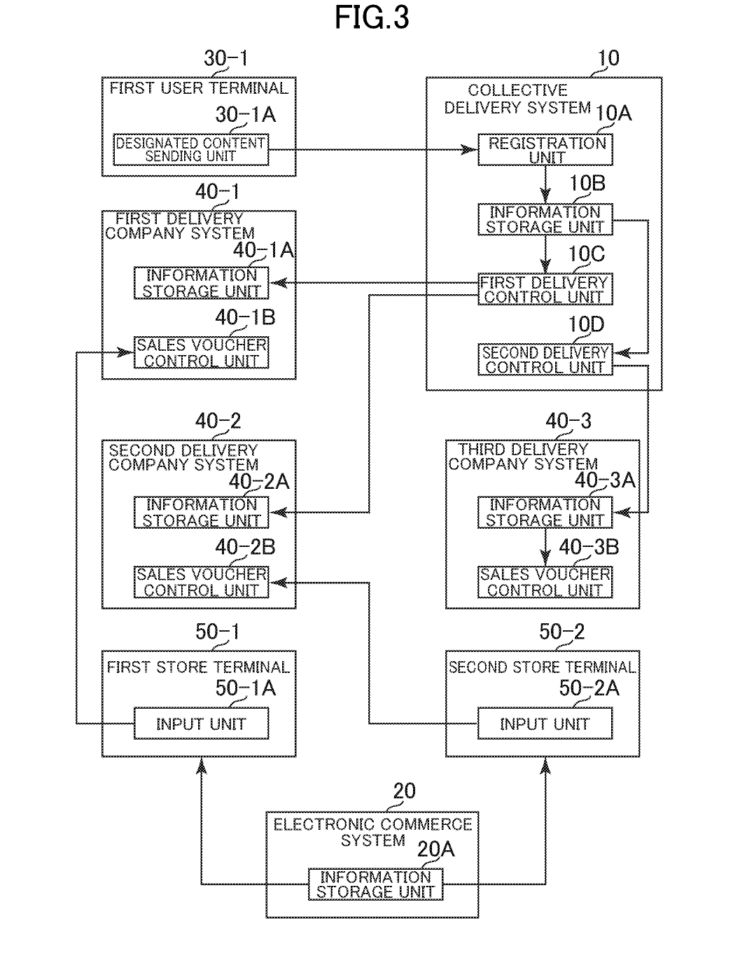

FIG. 3 is a function block diagram showing one example of functions implemented in this embodiment. Below, functions implemented by each of the collective delivery system 10, the electronic commerce system 20, the first user terminal 30-1, the first to third delivery company systems 40-1 to 40-3, and the first and second store terminals 50-1 and 50-2 will be described.

### [1-2-1. Functions Implemented at First User Terminal]

The first user terminal 30-1 includes a designated content sending unit 30-1A implemented mainly using the communication unit 33. The designated content sending unit 30-1A sends a condition (a date and time, a delivery company) for collective delivery designated by a user to the collective delivery system 10.

An example of a flow of processing for a user to designate a collective delivery condition is described below. That is, the first user terminal 30-1 accesses the collective delivery system 10 via a network. The collective delivery system 10 executes user authentication through communication with the first user terminal 30-1.

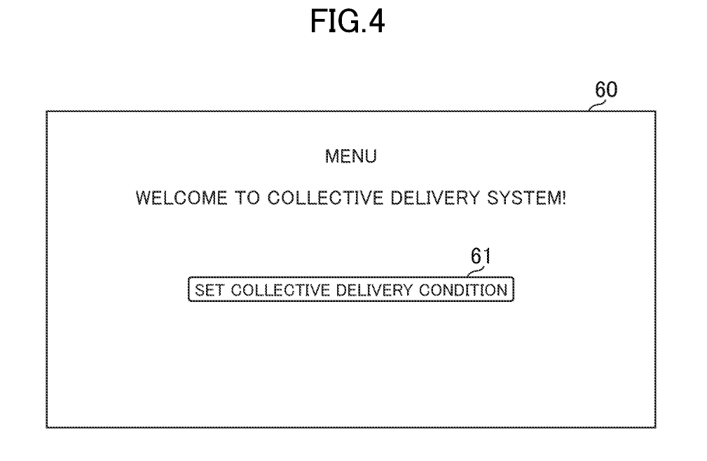

FIG. 4 shows one example of a menu screen that is displayed when authentication is successfully completed. As shown in FIG. 4, when user authentication is successfully completed, the collective delivery system 10 displays a menu screen 60 showing at least a set button 61 for setting a collective delivery condition on the display unit 35 of the first user terminal 30-1. More specifically, the collective delivery system 10 generates menu screen information corresponding to the menu screen 60, and sends to the first user terminal 30-1 via a network. The first user terminal 30-1 displays the menu screen 60 on the display unit 35, based on, specifically, by reading, the menu screen information received.

Upon detection of designation or selection of the set button 61 by a user on the menu screen 60, the first user terminal 30-1 sends information to that effect to the collective delivery system 10 through the network. The collective delivery system 10 then displays a designation screen for the user to designate a collective delivery condition on the display unit 35 of the first user terminal 30-1.

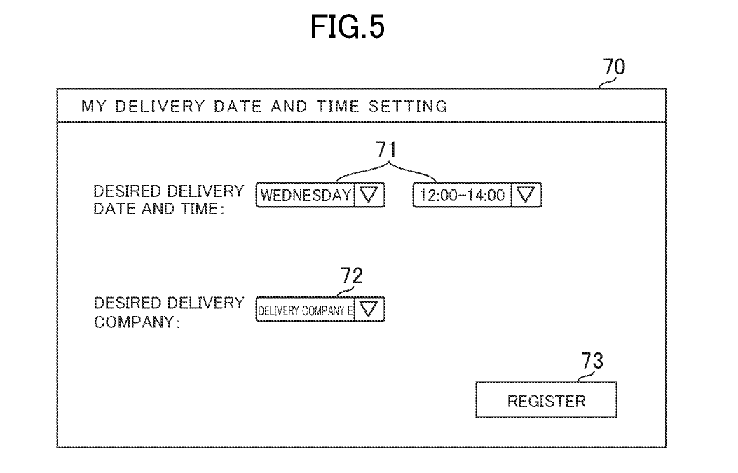

FIG. 5 shows one example of the designation screen for a user to designate a collective delivery condition. As shown in FIG. 5, an input form 71 for a user to designate its desired time and data for collective delivery and an input form 72 for a user to designate its desired delivery company are displayed on the designation screen 70. When a user selects a register button 73, the designated content sending unit 30-1A sends information indicating the delivery date and time designated by the user in the input form 71 and the delivery company designated by the user in the input form 72.

### [1-2-2. Functions Implemented in Electronic Commerce System]

The electronic commerce system 20 includes an information storage unit 20A implemented mainly using the database 21. The information storage unit 20A stores order information concerning an order made by a user. In this embodiment, the order information is notified to the store terminal 50-1 or 50-2 at a store that has received the order.

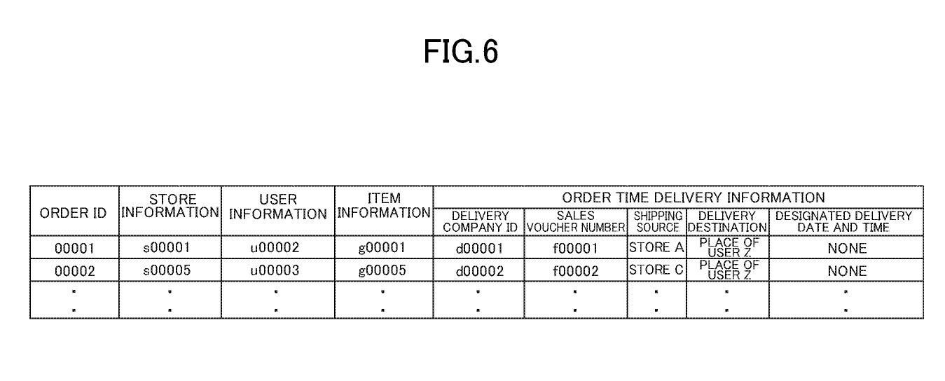

FIG. 6 shows one example of the order information. As shown in FIG. 6, the order information includes content of an order made by a user and information relevant to the order. For example, an order ID for uniquely identifying an order, store information, user information, item information, and order time delivery information are associated with the order information. Upon receipt of an order from a user, the electronic commerce system 20 generates the order information and stores in the database 21 of its own.

The store information is information concerning a store which has received an order, and includes, for example, a store ID for uniquely identifying the store. The user information is information concerning a user who has made an order, and includes, for example, a user ID for uniquely identifying the user. The item information is information concerning an item that has been ordered (order content), and includes, for example, an item ID for uniquely identifying an item dealt in the store and the quantity of items ordered. Assume that detail information on a store, a user, and an item are stored in the electronic commerce system 20.

The order time delivery information is delivery information decided on at the time of ordering an item. The order time delivery information is associated with, for example, a delivery company ID for uniquely identifying a delivery company, a sales voucher number for uniquely identifying a sales voucher, a shipping source, a delivery destination, and a designated delivery date and time. For example, the shipping source includes the address and name of a store; the delivery destination includes the address and name of a delivery destination. When delivery date and time is not designated, no information is included as a designated delivery date and time.

Note that an example of data included in the order information is not limited to the above described example. For example, a date and time when an order has been received may be included in the order information, and information for identifying the content of a package or a delivery fee may be included in the order time delivery information.

### [1-2-3. Functions Implemented at First Store Terminal and Second Store Terminal]

The first store terminal 50-1 includes an input unit 50-1A, while the second store terminal 50-2 includes an input unit 50-2A. The input units 50-1A and 50-2 are each implemented using an input device, such as a keyboard, a mouse, or the like, at the respective store terminals 50-1 and 50-2. The input units 50-1A and 50-2A are used to input various information items for printing a sales voucher. For example, a staff from each store inputs various information items to be included in the first delivery information, using the input unit 50-1A or 50-2A, based on the order information notified by the electronic commerce system 20.

### [1-2-4. Functions Implemented in Collective Delivery System]

The collective delivery system 10 includes a registration unit 10A, an information storage unit 10B, a first delivery control unit 10C, and a second delivery control unit 10D. Here, the information storage unit 10B is implemented mainly using the storage unit 12; the other functions are implemented mainly using the control unit 11.

The registration unit 10A registers in the information storage unit 10B information indicating a time designated by a user associated with a single delivery destination. In this embodiment, the designated content sent by the designated content sending unit 30-1A is registered in the information storage unit 10B. For example, the registration unit 10A records a desired delivery date and time (for example, a desired delivery day of the week) or a desired delivery time range designated by the user in the input form 71 in the information storage unit 10B so as to be associated with the user, and also a delivery company designated by the user in the input form 72 in the information storage unit 10B so as to be associated with the user.

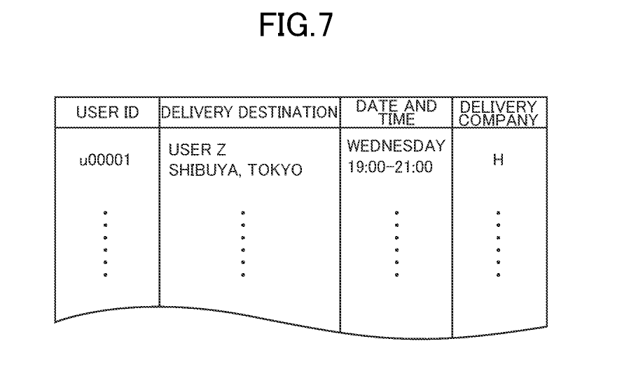

The information storage unit 10B stores setting information designated by the user. FIG. 7 shows an example of data included in the setting information. As shown in FIG. 7, a user ID, a delivery destination, desired delivery date and time, and a desired delivery company are included. The delivery destination refers to a designation of collective delivery desired by the user, and includes here the name (a name, a company name, etc.) and address of the user. The desired delivery date and time refers to a delivery date and time (arrival date and time) of a package to be collectively delivered, and refers to, for example, at least one of the date, a day of the week, a time, a time range, and timing, for example.

The first delivery control unit 10C can set the first delivery information to be associated with each package such that each of the plurality of different delivery companies delivers from the shipping source thereof to a holding center that is different from the single delivery destination. For example, the first delivery control unit 10C can change the delivery destination included in the first delivery information from the single delivery destination to the holding center. Note that although a case in which the first delivery control unit 10C sends an instruction for setting to the first delivery company system 40-1 and the second delivery company system 40-2 that manage the first delivery information will be described in this embodiment, the first delivery control unit 10C itself may manage the first delivery information and execute the setting processing.

The holding center is a predetermined place that can be designated as a delivery destination of packages to be delivered by a plurality of delivery companies, or a place to which packages delivered by respective delivery companies are gathered. In other words, the holding center is a relay point between a store and a user. In this embodiment, as respective package are packages that have been designated at the time of being ordered so as to be delivered to a single delivery destination, the first delivery control unit 10C can set the first delivery information to be associated with each of the packages having been ordered by changing the delivery destination from the single delivery destination to the holding center.

The second delivery control unit 10D can set the second delivery information to be associated with respective packages such that a single delivery company collectively delivers from the holding center to the single delivery destination. Note that although a case in which the second delivery control unit 10D sends an instruction for setting to the third delivery company system 40-3 that manages the second delivery information will be described in this embodiment, the second delivery control unit 10D itself may manage the second delivery information and execute setting processing.

The second delivery control unit 10D can set the second delivery information to be associated with respective packages so as to indicate that a single delivery company should collectively deliver from the holding center to the single delivery destination. In this embodiment, the second delivery control unit 10D sets the second delivery information to be associated with respective packages such that delivery will be made at a time determined based on the information registered by the registration unit 10A.

Also, the second delivery control unit 10D notifies the third delivery company system 40-3 of the content registered by the user. With the above, the third delivery company system 40-3 can specify when collective delivery should be made by which delivery company with respect to a user wishing collective delivery.

### [1-2-5. Functions Implemented in First and Second Delivery Company Systems]

The first delivery company system 40-1 includes an information storage unit 40-1A implemented mainly using a memory or the like and a sales voucher control unit 40-1B implemented mainly using a CPU or the like, while the second delivery company system 40-2 includes an information storage unit 40-2A implemented mainly using a memory or the like and a sales voucher control unit 40-2B implemented mainly using a CPU or the like. Note that as the functions of the information storage units 40-1A and 40-2A are the same, and those of the sales voucher control units 40-1B and 40-2B are the same, functions of the information storage unit 40-1A and the sales voucher control unit 40-1B will be described below.

The information storage unit 40-1A stores the content registered by a user and notified by the collective delivery system 10. That is, the information storage unit 40-1A stores information on a user for whom the delivery destination should be changed to the holding center. In this embodiment, the information storage unit 40-1A stores the user ID and the delivery destination (the user name and address) registered by the user. Note that the information storage unit 40-1A may store information same as the setting information shown in FIG. 7.

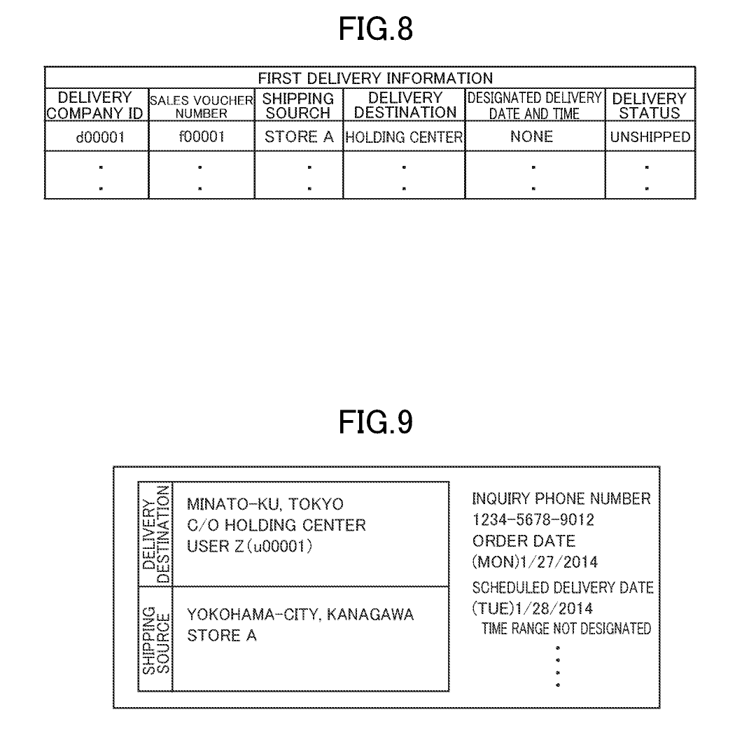

Also, the information storage unit 40-1A stores the first delivery information. The first delivery information is information for delivering a package collected from a store. FIG. 8 shows an example of data included in the first delivery information. As shown in FIG. 8, the data structure of the first delivery information is the same as that of the order time delivery information but different in that the former includes a delivery status.

The delivery status refers to a current situation of a package, indicating, for example, any of the statuses of being not yet shipped, shipped, and delivered (that is, unshipped status, shipped status, and delivered status, respectively), for example. Various publicly known methods are applicable as a method for updating the delivery status. For example, the delivery status is desirably updated depending on the delivery status of each item. For example, the initial value of the delivery status indicates the unshipped status. The delivery status is changed to the shipped status upon receipt by the first delivery company system 40-1 of information indicating completion of collection from a terminal, etc. used by a delivery person, and further to the delivered status upon receipt by the same of information indicating completion of delivery from a terminal etc. used by a delivery person.

The sales voucher control unit 40-1B generates and records the first delivery information based on the content inputted at the store terminal 50-1. At the store terminal 50-1, information for generating a sales voucher (for example, a shipping source, a delivery destination, and delivery date and time) is inputted. Upon receipt of the input from the store terminal 50-1, the sales voucher control unit 40-1B determines, based on the delivery destination, whether or not the user is a collective delivery target. For example, the sales voucher control unit 40-1B determines whether or not the delivery destination received from the store terminal 50-1 coincides with the delivery destination recorded in the information storage unit 40-1A.

When it is determined that the user is not a collective delivery target, the sales voucher control unit 40-1B generates the first delivery information to output a sales voucher without changing the delivery destination of the content inputted. Meanwhile, when it is determined that the user is a collective delivery target, the sales voucher control unit 40-1B changes the delivery destination included in the content inputted to the holding center and generates the first delivery information to output a sales voucher. That is, the sales voucher control unit 40-1B changes the delivery destination received from the store terminal 50-1 to the holding center.

FIG. 9 shows one example of a sales voucher printed at a store. As shown in FIG. 9, in a sales voucher of a package addressed to a user who is a collective delivery target, the delivery destination is not the place of the user etc. but is changed to the holding center. In this embodiment, assume that information for identifying a user (for example, a user ID, a user name, an address, etc.) is printed on a sales voucher. With the above, an operator in the holding center can specify to which user a package received is addressed. Note that a method for specifying a user addressed by a package delivered to the holding center is not limited to the above described, and any method is applicable as long as the final delivery destination is notified to an operator in the holding center or the third delivery company system 40-3.

### [1-2-6. Functions Implemented in Third Delivery Company System]

The third delivery company system 40-3 includes an information storage unit 40-3A and a sales voucher control unit 40-3B. The information storage unit 40-3A stores the content registered by a user and notified by the collective delivery system 10. Specifically, assume here that the information storage unit 40-3A stores a delivery destination (the name and address of a user), a delivery date and time, and a delivery company all designated by a user. Note that the information storage unit 40-3A may store information same as the setting information shown in FIG. 7.

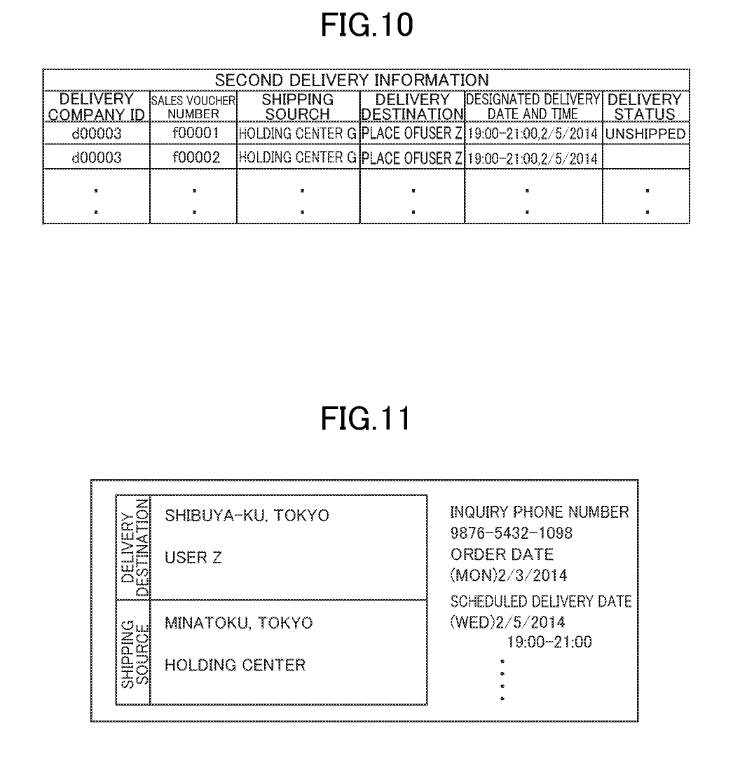

The information storage unit 40-3A stores second delivery information. The second delivery information is information for delivery from the holding center to the final delivery destination (user). FIG. 10 shows an example of data included in the second delivery information. As shown in FIG. 10, the data structure of the second delivery information is similar to that of the first delivery information, and each includes a delivery company ID, a sales voucher number, a shipping source, a delivery destination, a designated delivery date and time, and a delivery status.

The sales voucher control unit 40-3B generates the second delivery information of a package that is a collective delivery target. For example, when a package is delivered to the holding center, an operator in the holding center inputs the user ID printed on the sales voucher into the third delivery company system 40-3. The sales voucher control unit 40-3 then specifies the final delivery destination, etc. of the package based on the user ID, then generates the second delivery information, based on the content specified, and outputs a sales voucher.

FIG. 11 shows one example of a sales voucher printed in the holding center. As shown in FIG. 11, in a sales voucher of a package addressed to a user who is a collective delivery target, the place of the user is designated as the delivery destination. Note that a sales voucher may be printed for every package that is a collective delivery target, or a single sales voucher may be printed with respect to a plurality of packages that are collective delivery targets.

### [1-3. Processing Executed in First Embodiment]

In the following, processing executed in the first embodiment will be described. Below, (1) processing for a user to register a collective delivery condition, (2) processing for delivering a package to the holding center, and (3) processing for delivering the package to the place of the user etc. will be described. Each system operates according to a program whereby the processing described below is executed and respective function blocks are implemented.

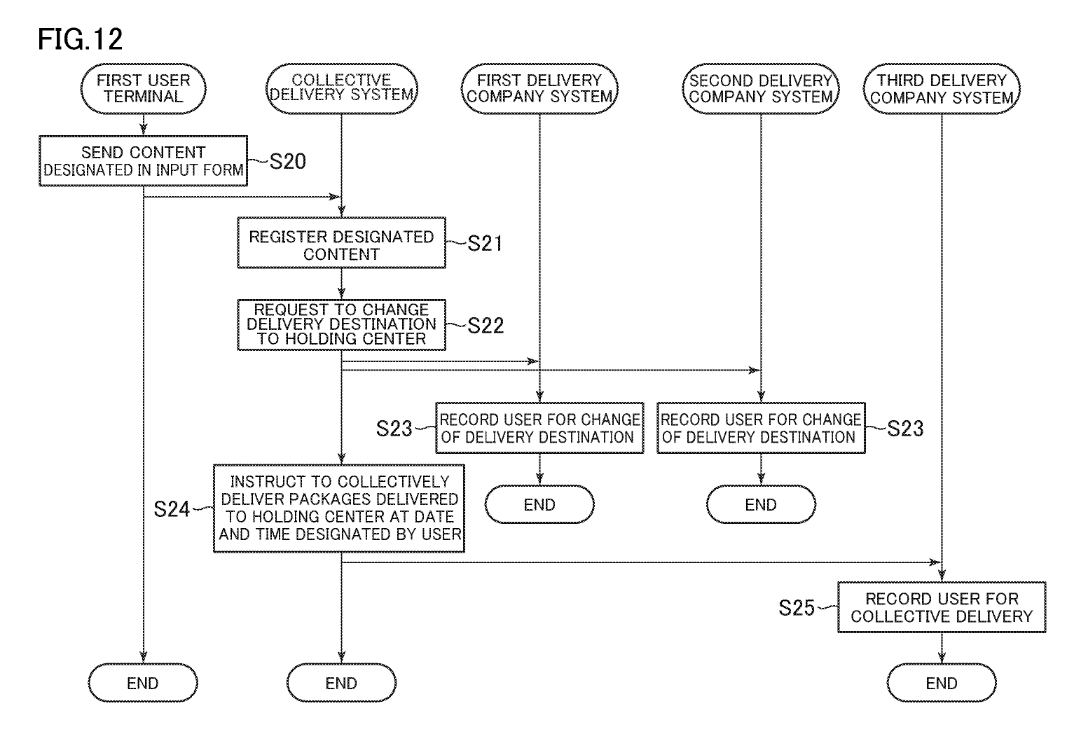

FIG. 12 shows processing for a user to register a collective delivery condition. Assume here that user authentication is made between the first user terminal 30-1 and the collective delivery system 10, and a designation screen 70 is displayed on the display unit 35 of the first user terminal 30-1. As shown in FIG. 12, the first user terminal 30-1 sends the content designated in the input forms 71 and 72 to the collective delivery system 10 (S20). A user ID as well is sent at S20.

In the collective delivery system 10, upon receipt of the content designated in the input forms 71 and 72, the control unit 11 registers the content designated (S21). At S21, the control unit 11 records the content designated by a user in the storage unit 12 so as to be associated with the user ID. Note that a delivery destination for the user (for example, the name or address of the user, etc.) may be stored in advance in the storage unit 12 or inputted on the designation screen 70.

The control unit 11 requests the first delivery company system 40-1 and the second delivery company system 40-2 to change the delivery destination of a package addressed to the user to the holding center (S22). At S22, the control unit 11 sends the user ID of the user having inputted the collective delivery condition and the delivery destination (for example, the name and address of the user, etc.) to the first delivery company system 40-1 and the second delivery company system 40-2.

Having received the request from the collective delivery system 10, the first delivery company system 40-1 and second delivery company system 40-2 record the user for whom the delivery destination is to be changed (S23). At S23, the user ID and the delivery destination (for example, the name and address of the user, etc.) received from the collective delivery system 10 are recorded.

Also, in the collective delivery system 10, the control unit instructs the third delivery company system 40-3 to collectively deliver the packages addressed to the user and delivered to the holding center at the date and time designated by the user (S24). At S24, the control unit 11 sends the user ID of the user having inputted the collective delivery condition, the delivery destination (for example, the name and address of the user, etc.), the delivery date and time, and the delivery company to the third delivery company system 40-3.

Having received the instruction from the collective delivery system 10, the third delivery company system 40-3 records the user for whom collective delivery should be made (S25). At S25, the user ID, the delivery destination (for example, the name and address of the user, etc.), the delivery date and time, and the delivery company received from the collective delivery system 10 are recorded.

With the above described processing executed, the first delivery company system 40-1 and the second delivery company system 40-2 can specify which delivery destination is a collective delivery target, and the third delivery company system 40-3 can specify the final delivery destination of the package held in the holding center.

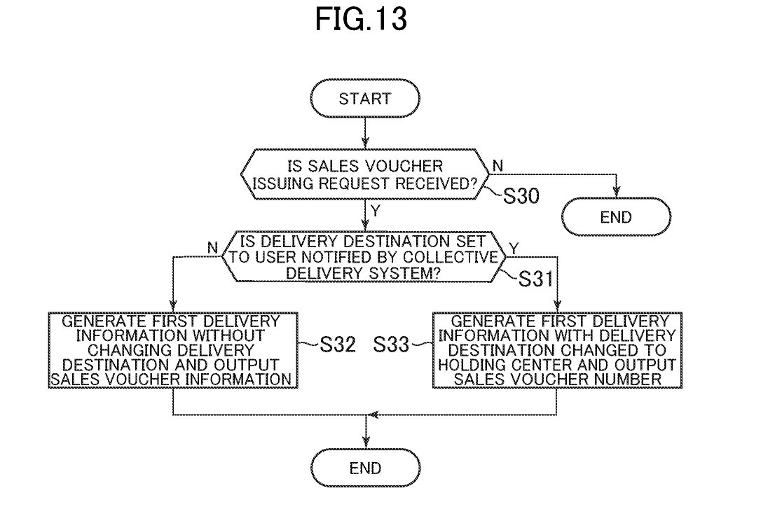

FIG. 13 shows processing for delivering a package to the holding center. As shown in FIG. 13, assume that each of the first delivery company system 40-1 and the second delivery company system 40-2 determines whether or not a sales voucher issuing request has been received from either the store terminal 50-1 or the store terminal 50-2 (S30). Further, assume that the sales voucher issuing request includes respective information items to be included in the first delivery information. Further, assume that the information is inputted by a staff from each store, using the store terminal 50-1 or the store terminal 50-2.

When it is determined that a sales voucher issuing request has been received (S30; Y), each of the first delivery company system 40-1 and the second delivery company system 40-2 determines whether or not the delivery destination relevant to the request is the user notified by the collective delivery system 10 (S31). At S31, whether or not the delivery destination received from the store terminal 50-1 or 50-2 coincides with the delivery destination notified by the collective delivery system 10 is determined.

When it is determined that the delivery destination is not the user notified by the collective delivery system 10 (S31; N), each of the first delivery company system 40-1 and the second delivery company system 40-2 generates the first delivery information without changing the delivery destination indicated by the sales voucher issuing request, and outputs sales voucher information (S32). In this case, as the package is not addressed to a user who is a collective delivery target, the delivery destination of the package is not the holding center but the delivery destination decided on at the time of order. The sales voucher information outputted at S32 is received at the store terminal 50-1 or the store terminal 50-2, and a sales voucher is printed. The sales voucher is thereafter attached to the package at the store, and the package is delivered directly to the place of the user, etc.

Meanwhile, when it is determined that the delivery destination is the user notified by the collective delivery system 10 (S31; Y), each of the first delivery company system 40-1 and the second delivery company system 40-2 changes the delivery destination to the holding center to generate the first delivery information and outputs the sales voucher information (S33). The sales voucher information outputted at S33 is received at the store terminal 50-1 or 50-2, and a sales voucher such as is shown in FIG. 9 is printed. The sales voucher is thereafter attached to the package at the store, and the package is delivered to the holding center.

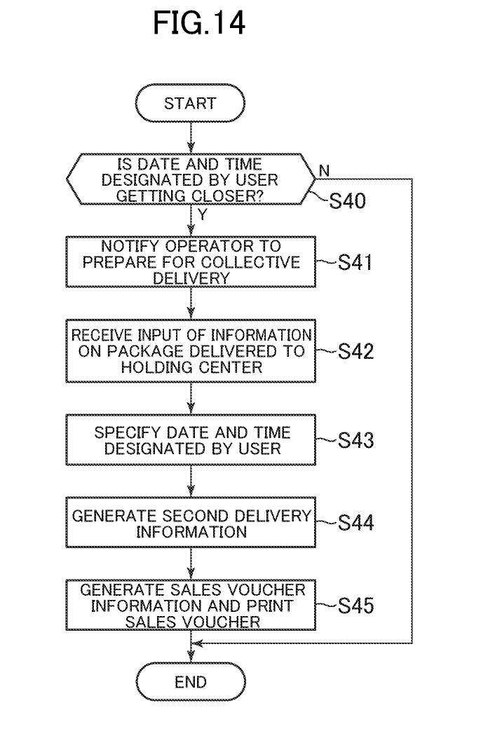

FIG. 14 shows processing for delivering a package to the place of a user, etc. As shown in FIG. 14, the third delivery company system 40-3 determines whether or not the date and time designated by the user is getting closer (S40). At S40, whether or not a date and time prior to the designated delivery date and time by a predetermined period of time has arrived is determined. In other words, whether or not a time to start preparation for collective delivery in order to make collective delivery at the date and time desired by the user has arrived is determined.

When it is determined that the date and time designated by the user is getting closer (S40; Y), the third delivery company system 40-3 notifies an operator to start preparation for collective delivery (S41). For example, at S41, information for identifying the user for whom collective delivery should be prepared is printed, or an alarm is displayed on a screen, to thereby notify an operator. An operator having received the notice checks whether or not a package addressed to the user has been delivered to the holding center. When such a package has not yet been delivered, subsequent processing is not executed. Meanwhile, when such a package has been delivered, subsequent processing is executed.

The third delivery company system 40-3 receives input of information on the package having been delivered to the holding center (S42). The input includes information items to be included in the second delivery information. Assume that the information is inputted by an operator in the holding center, using the third delivery company system 40-3.

The third delivery company system 40-3 specifies the date and time designated by the user who is a collective delivery target (S43), and generates the second delivery information, based on the date and time specified at S43 (S44). Further, the third delivery company system 40-3 generates sales voucher information and prints a sales voucher (S45). A sales voucher such as is shown in FIG. 11 is printed at the store terminal 50-1 or 50-2. Thereafter, the packages gathered in the holding center are delivered to the place of the user, etc.

According to the collective delivery system 10 in the first embodiment, by associating the first and second delivery information items with each of the packages, it is possible to complete receiving of all packages at one time as the respective packages gathered in the holding enter are delivered by a single delivery company even when delivery companies that collect the respective packages from the respective shipping sources are different, which can reduce trouble for the user to receive packages. In particular, in a case where a plurality of users order items for another user, the receiver user is likely to be bothered a plurality of times to receive the packages as it is not possible to designate the same delivery company for all items. However, with control by the collective delivery system 10, it is possible to complete receiving of all packages at one time.

More specifically, in a case where a plurality of users send packages to another user (for example, a midyear gift or a year-end gift, etc.), it is more likely that a variety of delivering companies will deliver such packages at a variety of times, compared to a case where a user sends a package to itself. In such a case, if a receiver user has registered in advance its desired delivery date and time, etc. in the collective delivery system 10, the collective delivery system 10 encourages the respective delivery companies or the electronic commerce system to deliver the packages addressed to the user to the holding center. This can reduce redelivery as the respective delivery companies need only deliver the packages to the holding center. Moreover, as the respective delivery companies can collect and deliver packages for their own convenience without taking into account a delivery date etc. designated by a user in delivering packages to the holding center, it is possible to enhance efficiency in delivery and also to reduce a space necessary in a warehouse. Meanwhile, as the receiver user can collectively receive all packages on its designated day, the user can be freed from trouble to arrange for redelivery. Further, if a receiving day is designated in advance, designation of a delivery day at the time of ordering an item is unnecessary, and a user can receive on its desired day even a package from others which the user does not know when will be delivered. Still further, all in all, while trucks conventionally have come and gone at the number of times same as the number of packages in the last one mile, according to the collective delivery system 10, it is possible to reduce the number of this comings and goings to only one time. As a result, it is possible to prevent occurrence of unnecessary comings and goings, to contribute to improve ecology by reducing the amount of exhaust gas from delivery trucks, and to achieve effective delivery.

Note that although a case in which the collective delivery system 10 cooperates with the first to third delivery company systems 40-1 to 40-3 has been described in the first embodiment, a relationship between the respective systems is not limited to the above described. That is, other than the above, for example, data may be shared between the collective delivery system 10 and the electronic commerce system 20. Below, a part of the processing relevant to collective delivery of items similar to the above described method will not be described and only a part different from the above described method will be described.

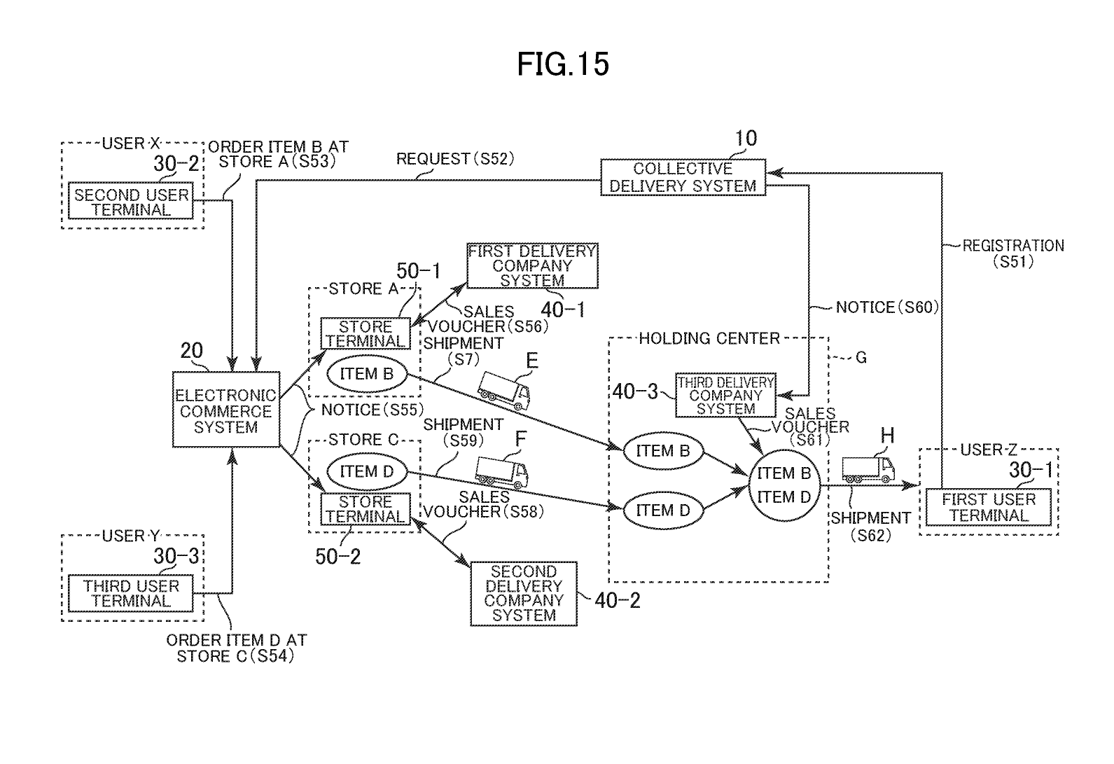

FIG. 15 shows an outline of processing executed by the collective delivery system 10. As shown in FIG. 15, S51 is similar to S1. In the collective delivery system 10, when an order addressed to a user Z is made, the delivery system 10 requests the electronic commerce system 20 to set the delivery destination of the order to the holding center in the process of ordering (S52).

Subsequent S53 to S62 are similar to S3 to S12, respectively, except that at S53 and S54, the electronic commerce system 20 changes the delivery destination to the holding center. At S55, the electronic commerce system 20 notifies of the content of the order with the holding center set as the delivery destination. Accordingly, at S56, a staff using the store terminal 50-1 inputs the holding center as the delivery destination to issue a sales voucher. Similarly, at S58, a staff using the store terminal 50-2 inputs the holding center as the delivery destination to issue a sales voucher. Assume here that the first delivery information is included in the order information, and managed by the electronic commerce system 20.

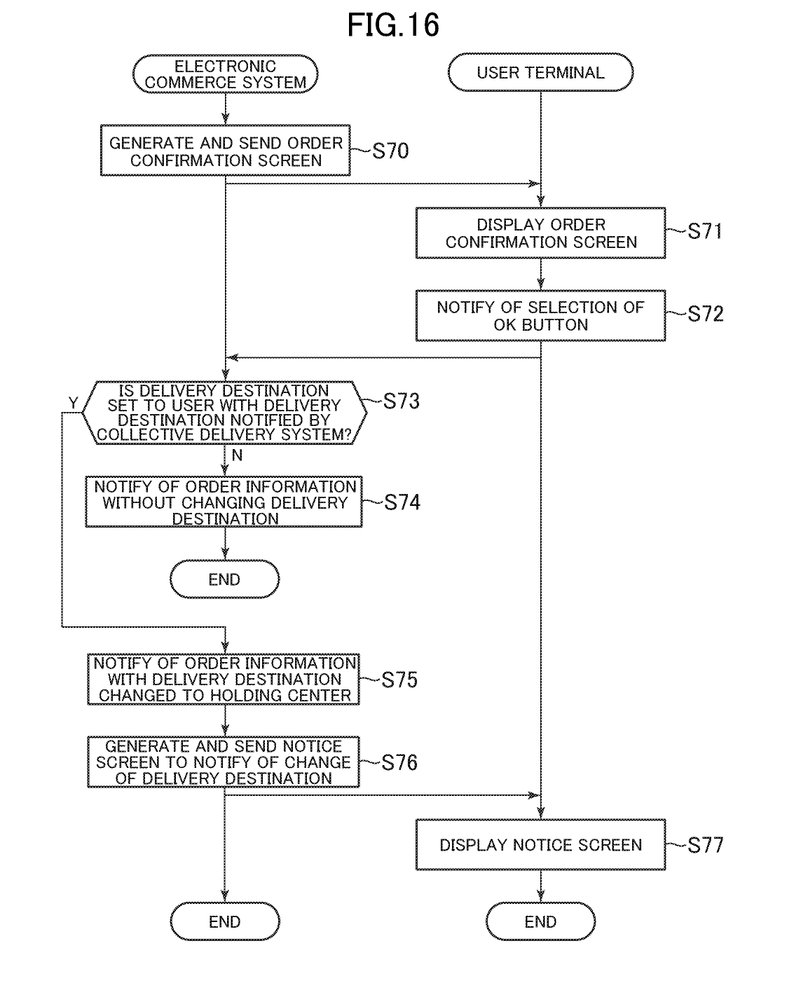

FIG. 16 shows processing executed by the electronic commerce system 20. The processing shown in FIG. 16 is executed when a user X or Y orders an item for a user A. Assume here that either the user X or Y selects an item to order for the user A and designates the place of the user A etc. as the delivery destination. As shown in FIG. 16, the electronic commerce system 20 generates and sends an order confirmation screen image for confirming the content of the order according to the order content supplied from the second user terminal 30-2 or the third user terminal 30-3 (S70).

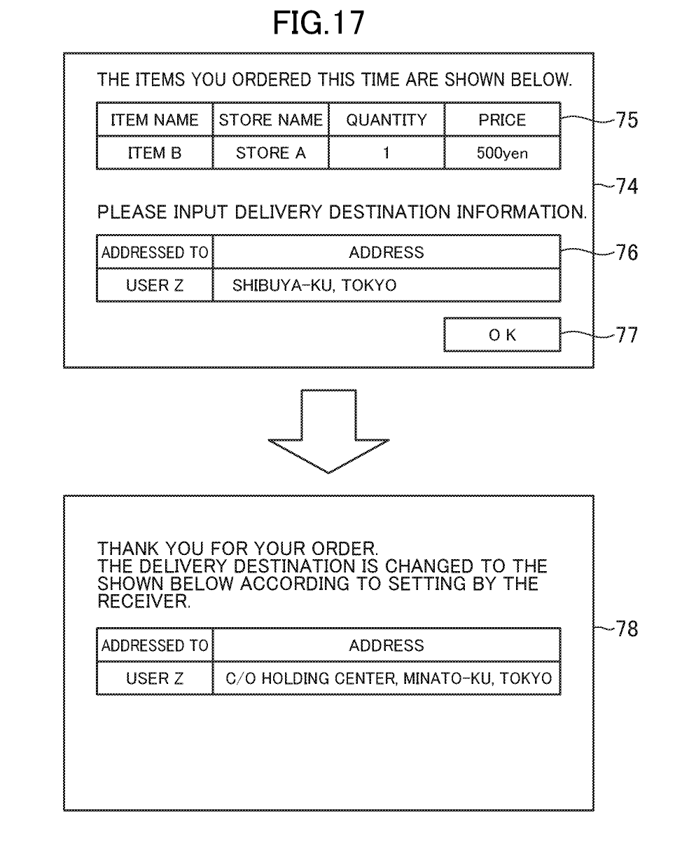

FIG. 17 shows one example of the order confirmation screen. As shown in FIG. 17, item information 75 indicating an item ordered by the user X or Y for the user A and delivery information 76 indicating the delivery destination are displayed on the order confirmation screen 74. The delivery information 76 indicates a delivery condition designated by the user X or Y. Specifically, as shown in FIG. 17, the name and address of the user A are inputted.

The second user terminal 30-2 or the third user terminal 30-3 displays the order confirmation screen 74 (S71), and notifies that the user X or Y has selected an OK button 77 (S72).

The electronic commerce system 20 determines whether or not the delivery destination inputted by the user X or Y is the user notified by the collective delivery system 10 (S73). At S73, the electronic commerce system 20 determines whether or not an order addressed to a user who is a collective delivery target has been received.

When it is determined that the delivery destination is not the user notified (S73; N), the electronic commerce system 20 notifies the store terminal 50-1 or 50-2 of the order information without changing the delivery destination (S74). In this case, as the order is not addressed to a user who is a collective delivery target, the delivery destination decided on at the time of order, rather than the holding center, is maintained as the delivery destination of the package. At the store terminal 50-1 or 50-2, a sales voucher is printed based on the information notified at S74. Thereafter, the sales voucher is attached to the package at each store and the package is delivered directly to the place of the user, etc.

Meanwhile, when it is determined that the delivery destination is the user notified by the collective delivery system 10 (S73; Y), the electronic commerce system 20 changes the delivery destination to the holding center and notifies the store terminal 50-1 or 50-2 of the order information (S75). At the store terminal 50-1 or 50-2, a sales voucher such as is shown in FIG. 9 is printed, based on the information notified at S75. Thereafter, the sales voucher is attached to the package at each store and the package is delivered to the holding center.

Further, the electronic commerce system 20 generates and sends a notice screen image for notifying change of the delivery destination (S76). That is, as shown in FIG. 17, it is notified by means of the notice screen 78 that the delivery destination has been changed according to the setting by the user Z.

At the second user terminal 30-2 or the third user terminal 30-3, the notice screen 78 is displayed (S77). With the above, the user X or Y can know that the delivery destination of the item ordered for the user A has been changed to the holding center.

As described above, in a case where the collective delivery system 10 cooperates with the electronic commerce system 20, it is possible to reduce trouble for a receiver user to receive a package by changing the delivery destination to the holding center at the time of order.

### 2. Second Embodiment

In the following, another embodiment according to the present invention will be described. While a case in which a plurality of users order items for another user has been described as an example in the first embodiment, a case in which a user orders items for itself is described in the second embodiment. Note that content similar to that in the first embodiment is not described below, and a part different from the first embodiment is described in the second embodiment.

### [2-1. Complete Structure of Collective Delivery System]

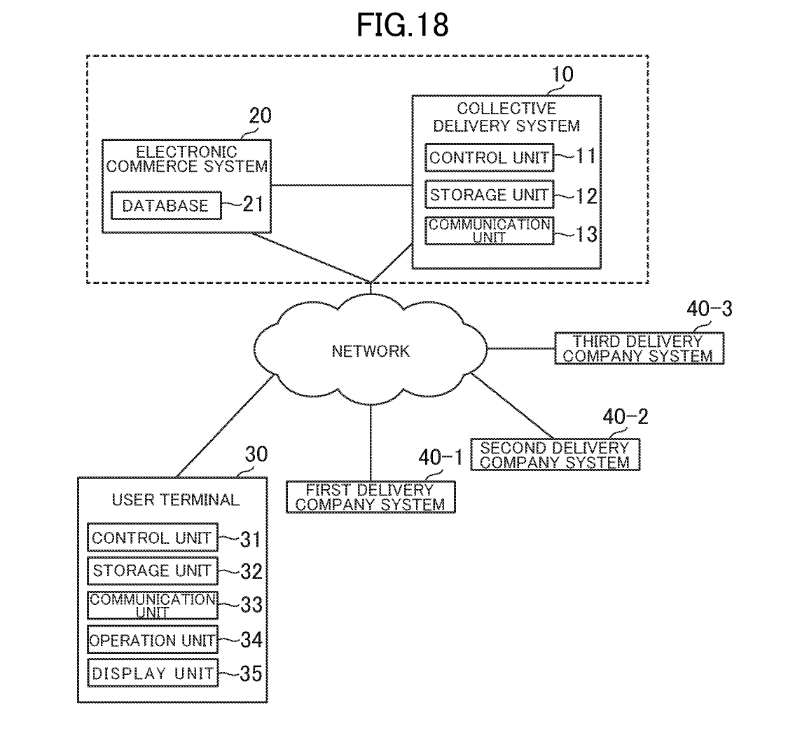

FIG. 18 shows a system structure according to the second embodiment. As shown in FIG. 18, in the second embodiment, a case in which the managing entity (for example, an operating company) of the collective delivery system 10 is the same as that of the electronic commerce system 20 and these make an integral system will be described. However, these may be separate systems, of which details are described later. Although it is assumed for brevity of description that there is a single electronic commerce system 20 in the description of this embodiment, there may be two or more electronic commerce systems 20, as will be described later. Further, in the second embodiment, as a user orders an item for itself, user terminals are not distinguished, like the first to third user terminals 30-1 to 20-3, as is in the first embodiment, but are simply referred to as a user terminal 30.

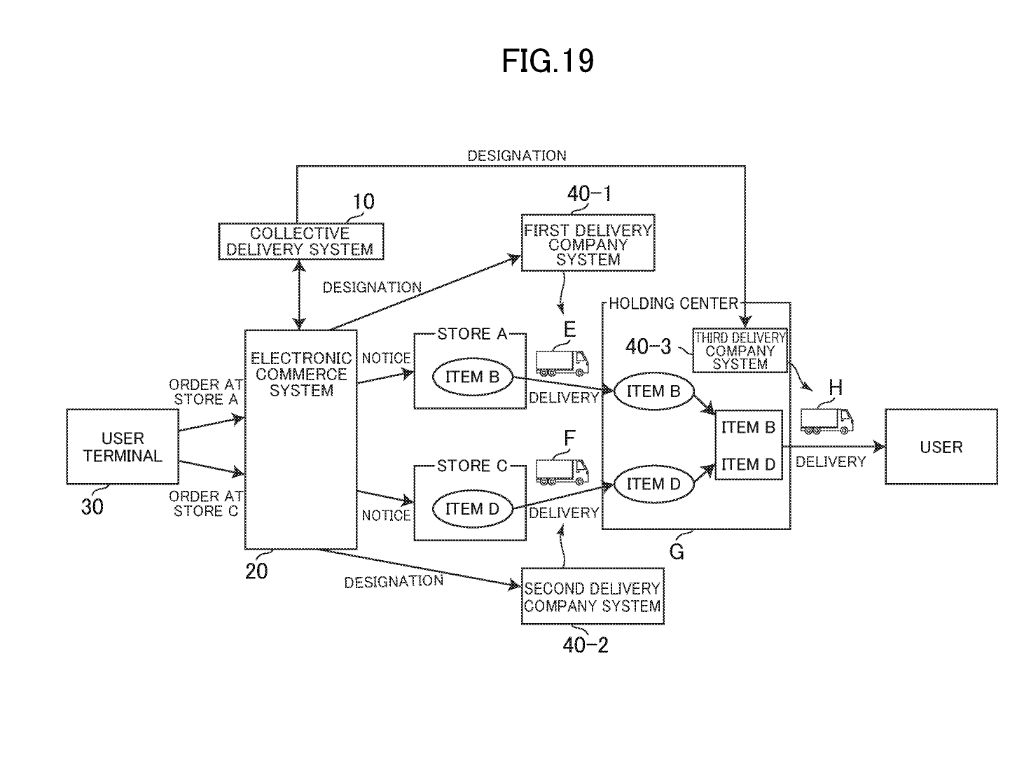

In this embodiment, processing executed by the collective delivery system 10 will be described with reference to a case as an example in which a user orders items at a plurality of stores. FIG. 19 shows an outline of the processing executed by the collective delivery system 10. For example, assume that a user orders an item B at a store A and an item D at a store C, using the electronic commerce system 20, and that a delivery company E collects the item B from the store A and a delivery company F collects the item D from the store C. In this case, conventionally, two delivery companies E and F separately visit the user, which results in two times of receiving occasions.

Regarding this point, in this embodiment, as shown in FIG. 19, the collective delivery system 10 instructs, through the electronic commerce system 20, the first delivery company system 40-1 of the delivery company E to deliver the item B from the store A to the holding center G and the second delivery company system 40-2 of the delivery company F to deliver the item D from the store C to the holding center G. Thereafter, the collective delivery system 10 instructs the third delivery company system 40-3 of a delivery company H (either E, F or any other will do) to deliver the items B and D gathered in the holding center G to the user, so that the user can receive both of the items B and D at one time. Below, details of this technique will be described.

[2-2. Functions Implemented in this Embodiment]

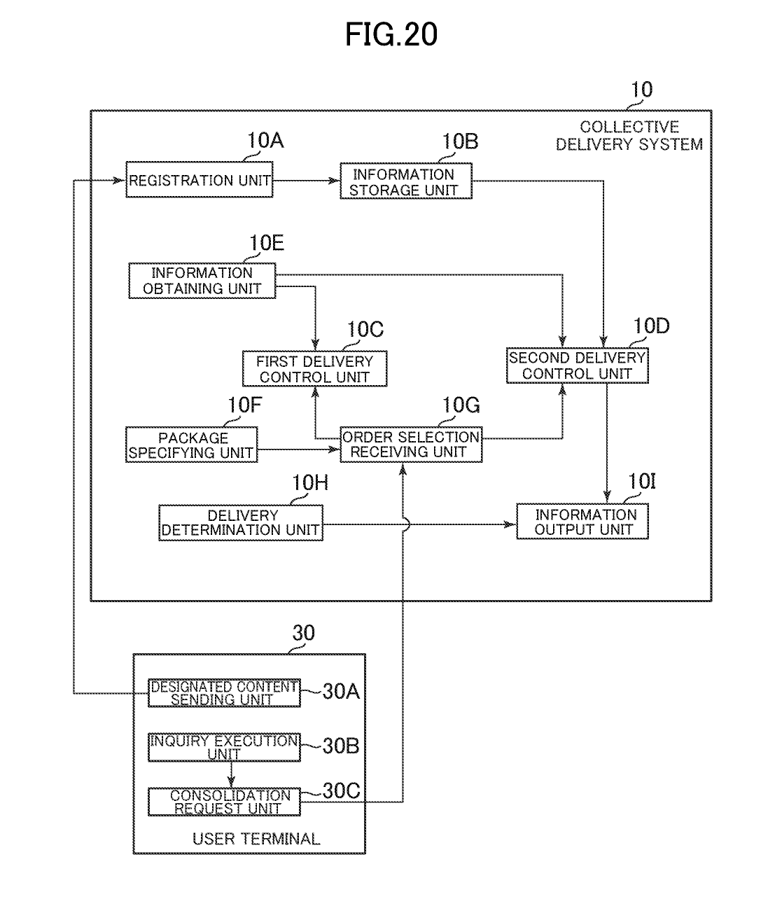

FIG. 20 is a function block diagram showing one example of functions implemented in this embodiment. Below, functions implemented by the collective delivery system 10 and the user terminal 30 will be described.

### [2-2-1. Functions Implemented in Collective Delivery System]

The collective delivery system 10 includes the registration unit 10A, the information storage unit 10B, the first delivery control unit 10C, the second delivery control unit 10D, an information obtaining unit 10E, a package specifying unit 10F, an order selection receiving unit 10G, a delivery determination unit 10H, and an information output unit 10I. The information storage unit 10B is implemented mainly using the storage unit 12, and the other functions are implemented mainly using the control unit 11.

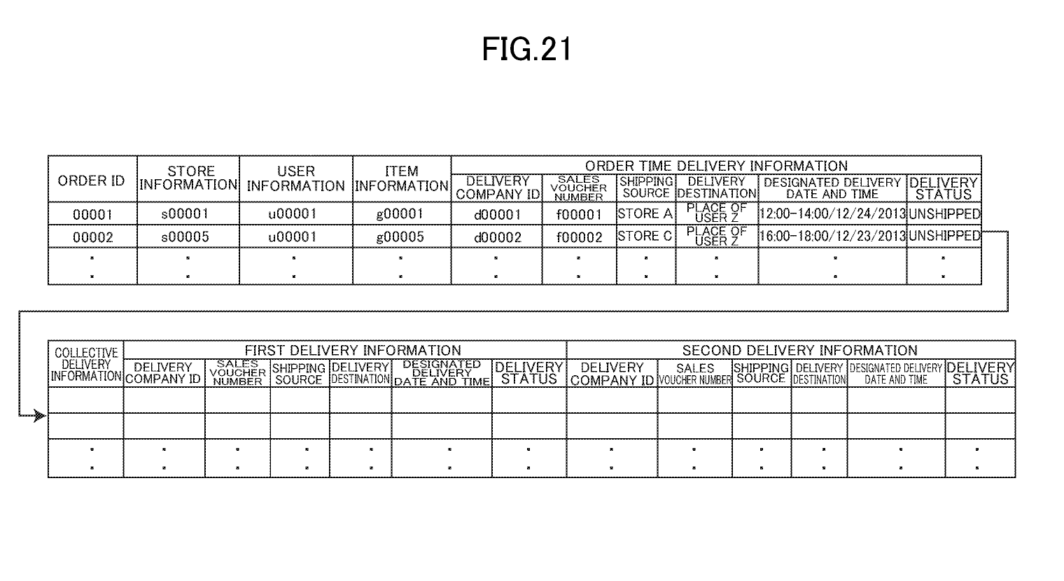

The information obtaining unit 10E obtains order information on an order made by a user. FIG. 21 shows one example of the order information. As shown in FIG. 21, the order information includes the content of an order made by a user and information relevant thereto, being associated with, for example, an order ID for uniquely identifying the order, store information, user information, item information, and delivery information. That is, upon receipt of an order from a user, the electronic commerce system 20 generates order information and stores in the database 21 of its own, and the information obtaining unit 10E will obtain the order information from the database 21.

The delivery information is information for a delivery company to deliver a package, and includes the order time delivery information, the collective delivery information, the first delivery information, and the second delivery information in this embodiment.

The order time delivery information is delivery information decided on at the time of ordering an item, and associated with, for example, a delivery company ID for uniquely identifying a delivery company, a sales voucher number for uniquely identifying a sales voucher, a shipping source, a delivery destination, a designated delivery date and time, and a delivery status. For example, the shipping source includes the address and name of a store; the delivery destination includes the address and name of a delivery destination. When no delivery date and time is designated, no information is included as the designated delivery date and time.

The delivery status refers to the current situation of a package, and indicates, for example, any of the unshipped status, the shipped status, and the delivered status. Various publicly known methods can be applied as a method for updating the delivery status. For example, the delivery status of each item is updated based on the information received from the delivery company system 40. For example, the initial value of the delivery status indicates the unshipped status, and the delivery status is changed to the shipped status upon receipt by the electronic commerce system 20 of information indicating completion of collection, and further to the delivered status upon receipt by the same of information indicating completion of delivery.

The collective delivery information is information for specifying an order with respect to which collective delivery should be made, and includes, for example, a collective delivery ID for uniquely identifying a combination of orders for which collective delivery should be made. Specifically, items of orders having a common collective delivery ID will be collectively delivered by a single delivery company here. There is no data included in the collective delivery information of an order that is not a collective delivery target. In this view, the collective delivery information can be rephrased as information indicating whether or not collective delivery is necessary.

The first delivery information is information for delivery from a store to the holding center; the second delivery information is information for delivery from the holding center to the final delivery destination (user). As shown in FIG. 21, the data structures of the first delivery information and second delivery information are similar to that of the order time delivery information, each including a delivery company ID, a sales voucher number, a shipping source, a delivery destination, a designated delivery date and time, and a delivery status. There is no data included in the first delivery information and the second delivery information of an order that is not a collective delivery target.

An example of data included in the order information is not limited to the above described example. For example, a date and time at which an order has been received may be included in the order information, and information for identifying the content of a package or a delivery fee may be included in the delivery information. Further, the data obtained by the information obtaining unit 10E is not limited to the above described example. The information obtaining unit 10E can obtain various information items from a system connected for data exchange with the collective delivery system 10.

The information storage unit 10B stores setting information designated by a user. The setting information is information about a delivery time and data (an arrival date and time) of a package to be collectively delivered. For example, the setting information indicates at least one of a date, a day of the week, a time, a time range, and timing. The information storage unit 10B stores the setting information for every user. In this embodiment, information for identifying a delivery company designated by a user as well is stored in the information storage unit 10B as a user designates a delivery company which the user wants to make collective delivery among a plurality of delivery companies.

The data stored in the information storage unit 10B is not limited to the above described example. For example, the order information may be stored in the information storage unit 10B. Further, the order information may be regularly ensured of its consistency with the order information stored in the electronic commerce system 20. Also, for example, information for identifying the holding center may be stored in the information storage unit 10B.

The registration unit 10A registers the setting information in the information storage unit 10B, as in the first embodiment. In the second embodiment as well, the designation screen 70 similar to that in the first embodiment is displayed, though the menu screen 60 may be different from that in the first embodiment.

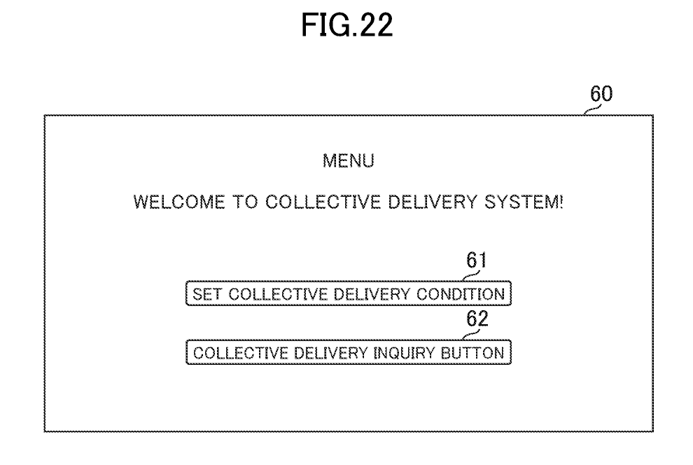

FIG. 22 shows one example of a menu screen displayed upon successful completion of user authentication. As shown in FIG. 22, when user authentication is successfully completed, the collective delivery system 10 displays the menu screen 60 showing at least the set button 61 and an inquiry button 62 on the display unit 35 of the user terminal 30.

Upon detection of designation or selection of the inquiry button 62 by a user on the menu screen 60, the user terminal 30 informs the collective delivery system 10 of that effect via a network. Then, the collective delivery system 10 displays an inquiry screen 80 to be described later on the display unit 35 of the user terminal 30.

The package specifying unit 10F specifies a package that is set so as to be delivered from the shipping source to the holding center. For example, the package specifying unit 10F refers to the first delivery information to specify a package with the holding center set as the delivery destination.

The order selection receiving unit 10G receives an order for which delivery is consolidated (that is, an order for collective delivery) selected from among orders made in the past. Alternatively, the order selection receiving unit 10G may receive a package for which delivery is consolidated selected from among the packages specified by the package specifying unit 10F. For example, a plurality of orders among orders made in the past may be presented to a user at the user terminal 30, and the order selection receiving unit 10G obtains an order selected by the user from among the plurality of orders presented. In this embodiment, the order selection receiving unit 10G receives orders with the same delivery destination set thereto and unshipped among the orders made in the past.

In a case where there are a plurality of packages that should to be delivered to a single delivery destination and collected from respective shipping sources by different delivery companies (for example, a delivery company decided on at the time of order), the first delivery control unit 10C in the second embodiment can set the first delivery information to be associated with each of these packages so as to indicate that the package should be delivered from the shipping source thereof to a place (for example, the holding center) different from the single delivery destination. Specifically, the first delivery control unit 10C in the second embodiment sets the shipping source indicated by the first delivery information to a place corresponding to the store where the order has been received, the delivery destination indicated by the same to the holding center, and the delivery company indicated by the same to the delivery company decided on at the time of order.

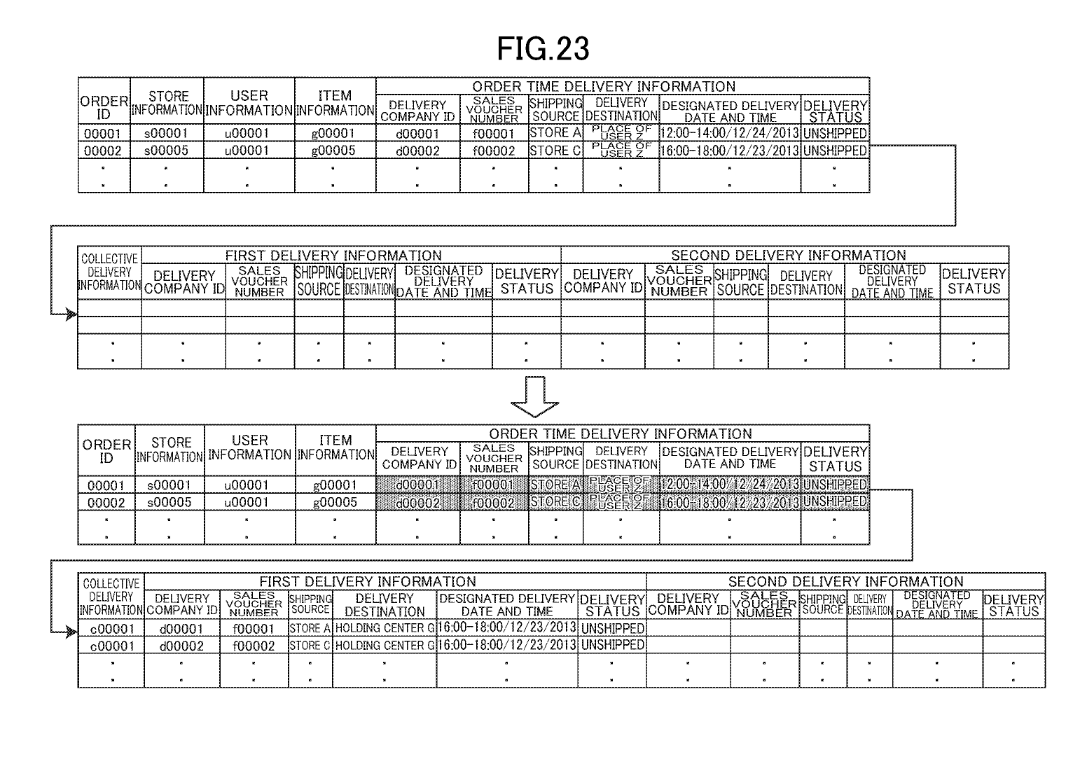

FIG. 23 explains processing executed by the first delivery control unit 10C. In this embodiment, an item having been ordered has order time delivery information associated therewith that indicates that the item should be delivered from the shipping source to the delivery destination decided on at the time of order by the delivery company decided on at the time of order. Therefore, as shown in FIG. 23, the first delivery control unit 10C changes the delivery destination indicated by the order time delivery information associated with each item having been ordered to the holding center, to thereby set the first delivery information to be associated with the item having been ordered. Note that, in FIG. 23, the order time delivery information of a package with the first delivery information set thereto is shown shaded as an item with the first delivery information set thereto will not be delivered based on the order time delivery information. Also, although, in the example of data included shown in FIG. 23, a sales voucher number same as that in the order time delivery information is used as a sales voucher number included in the first delivery information, these numbers may be different from each other.

Further, in this embodiment, as a user selects an order to be a collective delivery target, the delivery control unit 10C will change the delivery destination indicated by the order time delivery information associated with the item of each order which the user has selected. That is, the first delivery control unit 10C changes to the holding center the delivery destination of the item of an order which a user has selected from among the orders made in the past.

Also, for example, the first delivery control unit 10C sets the first delivery information to be associated with each of the respective packages such that the arrival dates and times at which the respective packages arrive at the holding center match with each other. Arrival dates and time that match with each other refer to arrival dates and times that are the same or different (a time difference) by an amount within a predetermined amount (for example, arriving in the same time range on the same day). Note that, as shown in FIG. 23 the designated delivery date and time indicated by the first delivery information may be set by setting the earliest date and time among those originally designated (the designated delivery date and time indicated by the order time delivery information) with respect to the other packages that are collective delivery targets as well. Alternatively, the designated delivery date and time indicated by the first delivery information may be desirably set based on at least one of the locations of the shipping source of a package, the holding center, and the final delivery destination, and the desired delivery time for collective delivery.

The delivery determination unit 10H determines whether or not packages for which deliveries should be consolidated have been delivered to the holding center. For example, the delivery determination unit 10H refers to the delivery status indicated by the first delivery information to execute the determination processing.

The second delivery control unit 10D in the second embodiment can set the second delivery information to be associated with the respective packages so as to indicate that a single delivery company should collectively deliver from the holding center to the single delivery destination. For example, the second delivery control unit 10D generates the second delivery information that indicates that a single delivery company should collectively deliver from the holding center to the delivery destination decided on at the time of order, and associates with respective items having been ordered.

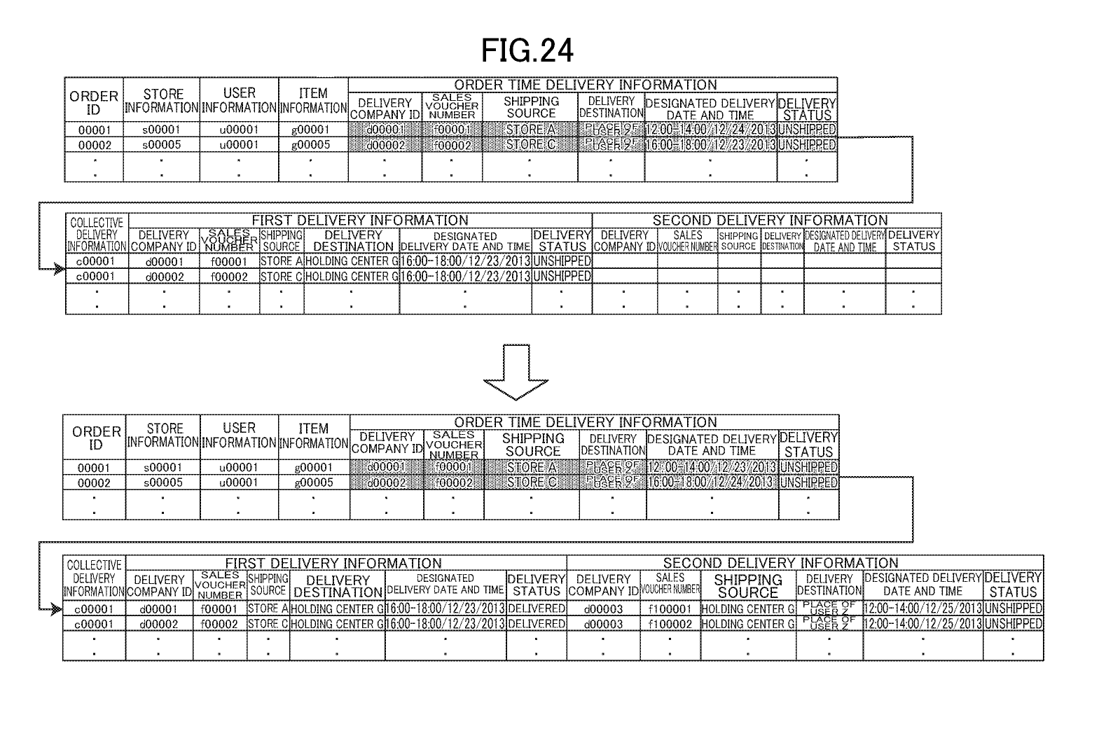

FIG. 24 explains processing executed by the second delivery control unit 10D. As shown in FIG. 24, the second delivery control unit 10D sets the shipping source indicated by the second delivery information to the holding center, the delivery destination indicated by the same to the delivery destination decided on at the time of order, and the delivery company indicated by the same to any of the plurality of delivery companies. The delivery company may be any of the delivery companies decided on at the time of order and other delivery companies or designated by a user. In a case where a user designates a delivery company, as in this embodiment, the second delivery control unit 10D sets the second delivery information such that the delivery company registered by the registration unit 10A (that is, the delivery company registered by the user on the designation screen 70) will deliver.

Further, as a user selects an order that makes a collective delivery target in this embodiment, the second delivery control unit 10D will associate the second delivery information generated with an item of each order which the user has selected. That is, the second delivery control unit 10D associates the second delivery information with an item of an order which a user has selected from among the orders made in the past.

Also, as the delivery date and time designated by a user is registered in advance, the second delivery control unit 10D sets the second delivery information to be associated with the respective packages so as to indicate that delivery should be made at a time determined based on the setting information registered by the registration unit 10A. That is, the second delivery control unit 10D sets the designated delivery date and time indicated by the second delivery information to a delivery date and time determined based on the setting information.

Note that the second delivery control unit 10D may generate the second delivery information upon determination by the delivery determination unit 10H that respective packages have been delivered to the holding center or at the same time when the first delivery information is generated. The processing by the second delivery control unit 10D of generating the second delivery information and associating with each package may be executed at any desired timing.

Note that each of the first delivery control unit 10C and the second delivery control unit 10D may implement the above described functions by accessing the database 21 of the electronic commerce system 20 or by sending a setting request or a change request to the electronic commerce system 20.

Upon determination that packages for which deliveries should be consolidated have been delivered to the holding center, the information output unit 10I outputs information for managing these packages as collective delivery targets. For example, the information output unit 10I sends the second delivery information generated by the second delivery control unit 10D to the third delivery company system 40-3. Note that an aspect of output by the information output unit 10I is not limited to the above described, and, other than the above, for example, to print a sales voucher based on the second delivery information may correspond to to output information for managing as a collective delivery target.

### [2-2-2. Functions Implemented at User Terminal]

The user terminal 30 includes a designated content sending unit 30A, an inquiry execution unit 30B, and a consolidation request unit 30C. Here, the designated content sending unit 30A and the consolidation request unit 30C are implemented mainly using the control unit 31 and the communication unit 33, while the inquiry execution unit 30B is implemented mainly using the control unit 31 and the display unit 35.

The designated content sending unit 30A sends a delivery date and time and a delivery company designated by a user to the collective delivery system 10. For example, the designated content sending unit 30A sends information indicating the delivery date and time which a user has designated in the input form 71 and the delivery company which the user has designated in the input form 72.

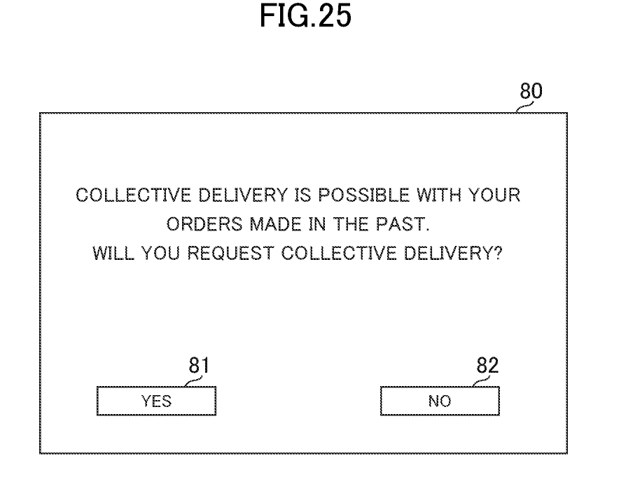

The inquiry execution unit 30B inquires of a user whether or not to make collective delivery. FIG. 25 shows one example of a screen for inquiring whether or not to make collective delivery. When the user selects a button 81 on the inquiry screen 80, a list for selecting an order to be a collective delivery target is displayed on the inquiry screen 80. Meanwhile, when the user selects a button 82, the consolidation request unit 30C does not send a consolidation request.

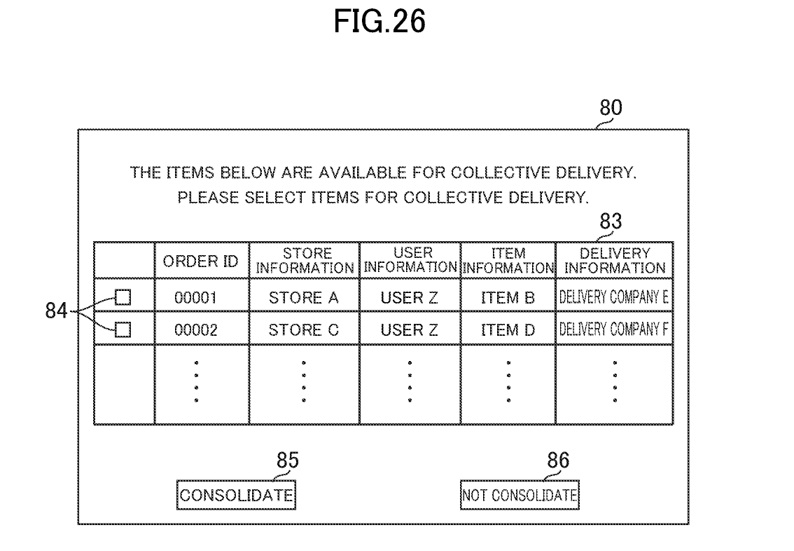

FIG. 26 shows one example of the inquiry screen 80 on which the list is displayed. As shown in FIG. 26, on the inquiry screen 80, a list 83 of orders with items yet to be shipped among the orders made by a user in the past is displayed. By checking a check box 84 and then selecting a button 85, the user selects a combination of orders for which deliveries are consolidated. Note that, as there may be a case in which delivery destinations are different even though the user is the same, it is assumed that a combination of different delivery destinations cannot be selected. When the user selects the button 85, the consolidation request unit 30C sends information identifying the order selected as a collective delivery target by the user to the collective delivery system 10. Meanwhile, when the user selects a button 86, the consolidation request unit 30C does not send a consolidation request.

The consolidation request unit 30C sends a reply from the user with respect to the inquiry by the inquiry execution unit 30B. For example, when the user has selected the button 81, inputted a check in the check box 84, and selected the button 85, the consolidation request unit 30C obtains a combination of orders designated by the user and sends together with a consolidation request. Meanwhile, when the user has selected the button 82 or the button 86, the consolidation request unit 30C does not send a consolidation request. Note that an aspect of sending a consolidation request is not limited to an aspect of sending from the inquiry screen 80, and any aspect will do as long as a consolidation request is sent upon a predetermined operation executed by a user at the user terminal 30.

### [2-3. Processing Executed in SECOND Embodiment]

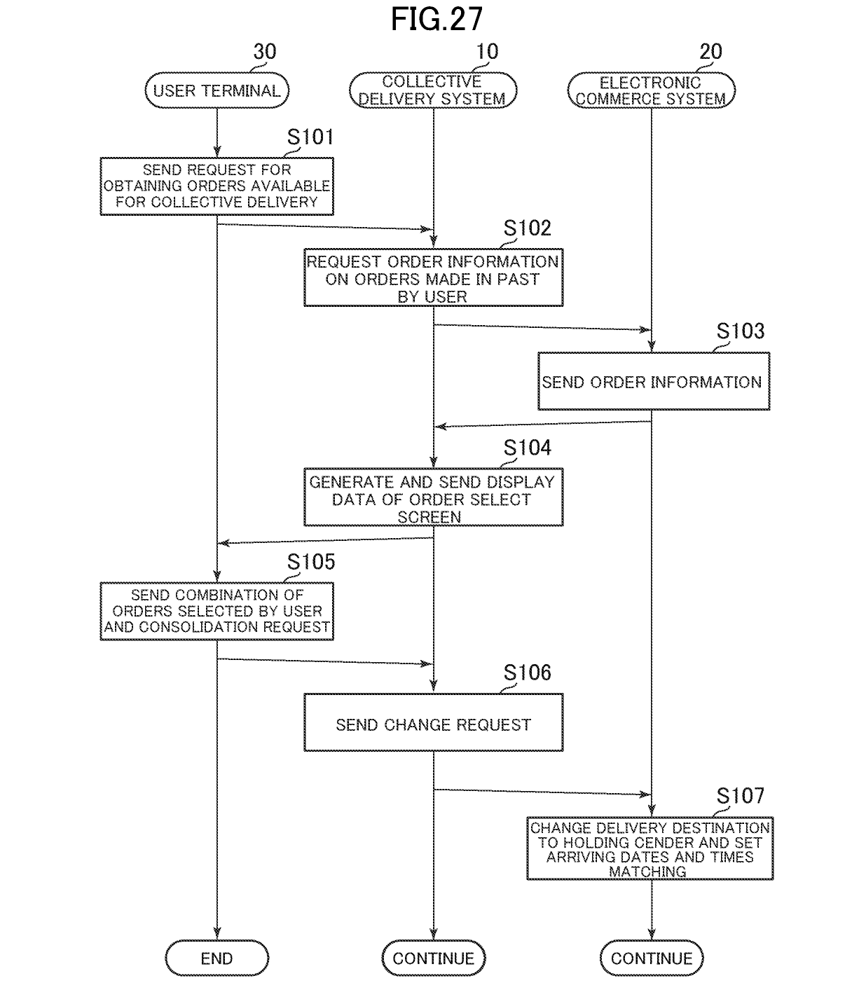

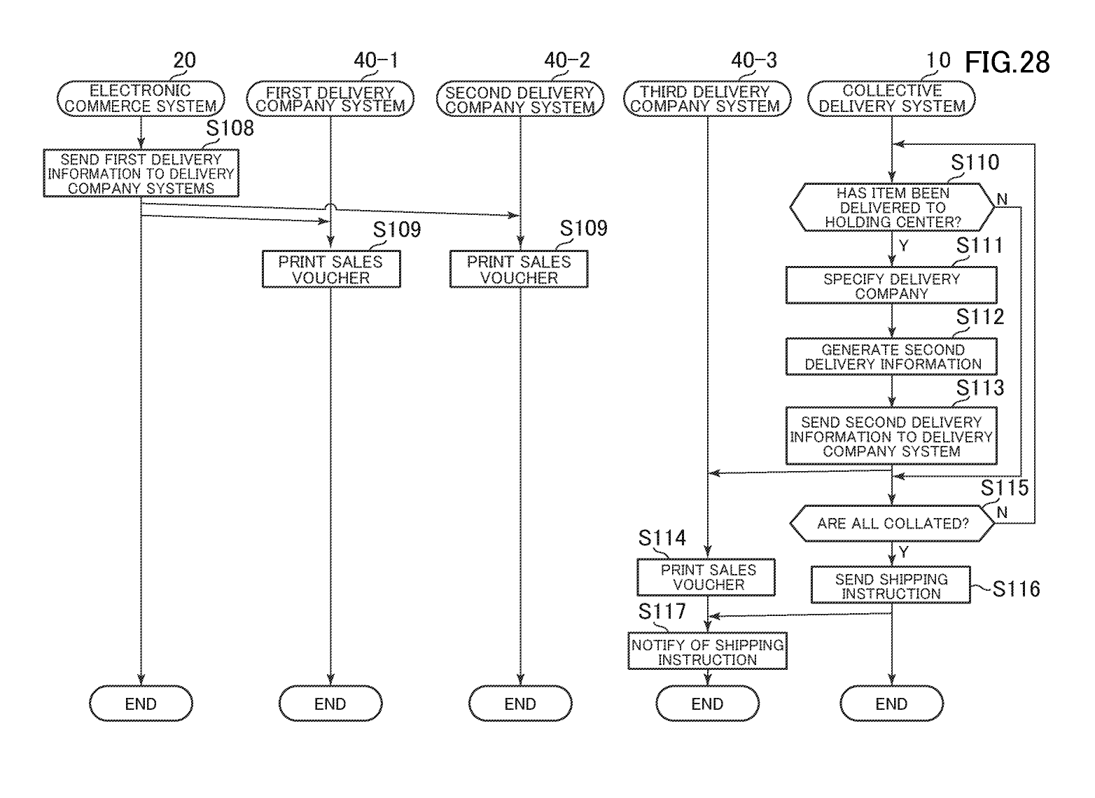

FIGS. 27 and 28 show processing executed in the second embodiment. Assume here that each system operates according to a program to thereby execute the processing shown in FIGS. 27 and 28 and implement the respective function blocks. Also assume that for execution of subsequent processing, a user has already made a plurality of orders in the electronic commerce system 20, and that the inquiry screen 80 is displayed on the display unit 35 of the user terminal 30.

As shown in FIG. 27, initially, upon selection of the button 81 on the inquiry screen 80 at the user terminal 30, the control unit 31 sends an obtaining request for obtaining an order available for collective delivery to the collective delivery system 10 (S101). The user terminal 30 sends a user ID as well.

In the collective delivery system 10, upon receipt of the obtaining request, the control unit 11 sends an obtaining request for obtaining order information of an order made in the past by the user having sent that request to the electronic commerce system 20 (S102). At S102, the control unit 11 makes an obtaining request for obtaining order information including the user ID of the user having sent the obtaining request.

Upon receipt of the obtaining request for obtaining order information, the electronic commerce system 20 sends order information corresponding to the user to the collective delivery system 10 (S103). At S103, the electronic commerce system 20 specifies order information including the user ID of the user having made the obtaining request, and then sends order information of an item unshipped, with reference to the delivery status included in the order information specified.

In the collective delivery system 10, upon receipt of the order information, the control unit 11 generates display data for the list 83 for having the user to select an order to be a consolidation target, and sends to the user terminal 30 (S104).

At the user terminal 30, the list 83 is displayed on the inquiry screen 80. Then, when the button 85 is selected, the control unit 31 sends information for identifying the combination of orders selected by the user and a consolidation request to the collective delivery system 10 (S105). At S105, the user terminal 30 sends a combination of order IDs with respect to which the user has inputted a check in the respective check boxes 84 thereof.

In the collective delivery system 10, upon receipt of the information for identifying a combination of orders and the consolidation request, the control unit 11 sends to the electronic commerce system 20 a change request for changing the delivery destinations of these orders (S106). At S106, the control unit 11 requests to change the delivery destination included in the order information including the order ID selected by the user from the delivery destination decided on at the time of order to the holding center. Also, in executing the processing at S106, the control unit 11 may generate a collective delivery ID, based on a predetermined ID generation method, and send to the electronic commerce system 20.

In response to the change request received from the collective delivery system 10, the electronic commerce system 20 changes the delivery destinations of the orders selected by the user to the holding center and sets such that the arrival times and dates thereof match with each other (S107). At S107, the electronic commerce system 20 includes the collective delivery ID into the order information of an order that is a collective delivery target, and changes the delivery destination in the order time delivery information to the holding center, to thereby make the first delivery information. Further, the designated delivery dates and times in the first delivery information items are set such that the arrival times and dates at which the respective items that are collective delivery targets arrive at the holding center match with each other. The delivery destination before change (the delivery destination decided on at the time of order) is held in the collective delivery system 10 or the electronic commerce system 20 until generation of the second delivery information (for example, not deleting but holding the order time delivery information). Alternatively, the delivery destination before change may be inputted as the delivery destination included in the second delivery information to be held.

In FIG. 28, with reference to the delivery company ID in the first delivery information, the electronic commerce system 20 specifies an entity to which to send the first delivery information (here, either the first delivery company system 40-1 or the second delivery company system 40-2), and sends corresponding first delivery information to the first delivery company system 40-1 or second delivery company system 40-2 specified (S108). At S108, for example, when the electronic commerce system 20 receives information indicating completion of preparation for shipment of an item from a terminal of each store, the electronic commerce system 20 sends the first delivery information to the first delivery company systems 40-1 and 40-2 corresponding to the delivery company ID indicated by the first delivery information. Alternatively, similar to the first embodiment, the content of the first delivery information may be notified to the first delivery company system 40-1 or the second delivery company system 40-2 when being inputted by a staff from each store.

The first delivery company systems 40-1 and 40-2 print a sales voucher based on the first delivery information received from the electronic commerce system 20 (S109). The sales voucher printed at S109 is a sales voucher for delivering the item from the store to the holding center and to be attached to a box for packing the item, for example. Note that a sales voucher may be printed on a printer connected to a store terminal operated at a store, and attached at the store.

When the sales voucher is printed at S109, a delivery company collects the item from the store. Then, the delivery company system 40 sends information indicating completion of shipment of the item to the electronic commerce system 20, upon which the delivery status indicated by the first delivery information of the item is changed. Following the sales voucher printed, the delivery company delivers the collected item to the holding center. After delivering the item to the holding center, the delivery company system 40 sends information indicating completion of delivery of the item to the electronic commerce system 20, upon which the delivery status indicated by the first delivery information of the item is changed.

In the collective delivery system 10, the control unit 11 determines whether or not the item that is a collective delivery target has been delivered to the holding center (S110). At S110, regularly referring to the delivery status of each item that is a collective delivery target, the control unit 11 monitors whether or not the delivery status of the item has become the delivered status.

When it is determined that the package has been delivered to the holding center (S110; Y), the control unit 11 specifies a delivery company which should make collective delivery (S111). Although a case in which the control unit 11 specifies the single delivery company that has been designated in advance by the user will be described here, any of the delivery companies relevant to the respective packages that are collective delivery targets may be selected.

The control unit 11 generates the second delivery information (S112). At S112, the control unit 11 initially generates a sales voucher number, based on a predetermined generation method, and then sets the delivery company ID indicated by the second delivery information to the delivery company ID of the delivery company specified at S111, the shipping source to the holding center, and the delivery destination to the original delivery destination, to thereby generate the second delivery information. Further, the control unit 11 sends the second delivery information generated to the electronic commerce system 20 to be included as the second delivery information of an item that is a consolidation target to thereby associate the second delivery information with each of the items that are collective delivery targets.

The control unit 11 sends the second delivery information generated at S112 to the third delivery company system 40-3 of the delivery company specified at S111 (S113). Note that the second delivery information may be sent via the electronic commerce system 20 to the third delivery company system 40-3.

The third delivery company system 40-3 prints a sales voucher based on the second delivery information received (S114). The sales voucher printed at S114 is for delivery of the respective items gathered in the holding center to the original delivery destination thereof.

Below, an operation of a delivery company in the holding center will be described. That is, upon arrival of a package that is a collective delivery target at the holding center, a sales voucher for delivering the package to its final delivery destination (for example, the place of a user) is printed in the processing at S114. Then, the delivery company attaches the sales voucher to the package to manage the package as a collective delivery target in the holding center.

Specifically, in the holding center, there is available a predetermined area (hereinafter referred to as a consolidation target storage area) where to manage packages that are collective delivery targets. A dedicated consolidation target storage area is available for every user, and, for example, at every arrival of a package of an order that is a collective delivery target at the holding center, the package is stored in the consolidation target storage area corresponding to the user having made that order. More specifically, in the example of data included shown in FIG. 24, when an item with the order ID “00001” arrives at the holding center, the delivery company prints and attaches a sales voucher with the sales voucher number “f100001”, and moves the item to the consolidation target storage area corresponding to the user. Similarly, when an item with the order ID “00002” arrives at the holding center, the delivery company prints and attaches a sales voucher with the sales voucher number “f100002”, and moves the item to the consolidation target storage area. The delivery company will ship these packages gathered in the consolidation target storage area at predetermined timing.

As described above, in the holding center, the delivery company prints and attaches a sales voucher every arrival of a consolidation target package, and moves the package to the consolidation target storage area to store therein. Note that although a case in which collective delivery is made after all collective delivery target packages have been arrived is described in this embodiment, collective delivery may be made with only packages having been arrived by predetermined timing in a case where all such packages have not been arrived by then.

In the collective delivery system 10, the control unit 11 determines whether or not all collective delivery target packages have been delivered to the holding center (S115). Specifically, at S115, the control unit 11 refers to the first delivery information of each of the packages having a common collective delivery ID to determine whether or not the delivery statues of all such packages indicate the delivered status.

When it is determined that there is a package yet to be delivered to the holding center (S115; N), the process returns to S110. In this case, the processing at S110 to S114 is repetitively executed until all collective delivery target packages will have been arrived in the holding center. That is, every arrival of a collective delivery target package at the holding center, the second delivery information is generated and sent, and sales voucher information for collective delivery of the package is outputted.

Meanwhile, when it is determined that all collective delivery target packages have been delivered to the holding center (S115; Y), the control unit 11 sends a shipping instruction for collective delivery to the third delivery company system 40-3 (S116). A shipping instruction is a notice for permitting shipment of the packages stored in the holding center, and includes a collective delivery ID for collective delivery and sales voucher information, for example.

The third delivery company system 40-3 notifies a delivery company of the shipping instruction received (S117). The notice at S117 may be made by, for example, displaying a predetermined screen in the third delivery company system 40-3 or printing an image indicating a shipping instruction. Other than the above, a shipping instruction may be notified by means of sound. When a shipping instruction for collective delivery is notified, the delivery company collectively delivers the respective packages gathered in the consolidation target storage area according to the shipping instruction. Note that, in this case as well, the delivery status indicated by the second delivery information is desirably updated.

According to the collective delivery system 10 in the above described embodiment, by associating the first delivery information and the second delivery information with each package, it is possible to complete receiving of all packages at one time even when delivery companies that collect the packages from respective shipping sources are different as a single delivery company delivers the packages gathered in the holding center. This can reduce trouble for the user to receive the packages. In particular, as there is a store that can use only a specific delivery company due to the content of an agreement between the store and the delivery company, a situation may likely be caused in which different delivery companies are set when a user has made orders at a plurality of stores. According to the electronic commerce system 20, it is possible to effectively reduce trouble to receive in such a situation. Also, although, when a store newly introduces a delivery company which the store has not used so far, it is necessary for the store to introduce a system of the delivery company, the collective delivery system 10 enables collective delivery without having the store introduce a new system.

Also, even when the delivery company set to an item having been ordered is different, it is possible to have the item having been ordered gathered in the holding center and delivered by a single delivery company by changing the delivery destination included in the first delivery information thereof to the holding center and setting the delivery destination included in the second delivery information thereof to the original delivery destination designated at the time of order.

Also, as it is possible to have a user select an order for collective delivery, it is possible to make collective delivery in accordance with preference of the user. For example, depending on an item, a user may wish to receive sequentially beginning with one ready for shipment, rather than in collective delivery. In such a case, it is possible to properly use either collective delivery or individual delivery, depending on preference of the user.

Also, by setting the designated delivery date and time included in the second delivery information, based on the setting information registered in advance, it is possible to save trouble for a user to designate a delivery date and time each time. For example, when a day of the week or time range when a user relatively likely stays in its place is registered in advance, the user can collectively receive packages at that time.

Also, by matching the dates and times when respective collective delivery target packages arrive at the holding center with each other, it is possible to facilitate management of the collective delivery target packages in the holding center. Also, by setting such matching dates and times for arrival close to the date and time for shipment from the holding center, it is possible to shorten the period of time for having the packages stored in the holding center. This contributes to reduction of a capacity necessary in the holding center.

Also, by generating and outputting the second delivery information and printing a sales voucher in the third delivery company system 40-3 upon arrival of a package that is a collective delivery target at the holding center, it is possible to facilitate an operation (a sorting operation) for managing the packages having arrived at the holding center. For example, although many packages are delivered to the holding center, it is possible to readily know which package should be collectively delivered with which package.

### 3. Modified Example

Note that the present invention is not limited to the above described embodiments, and can be desirably modified without departing from the gist of the present invention.

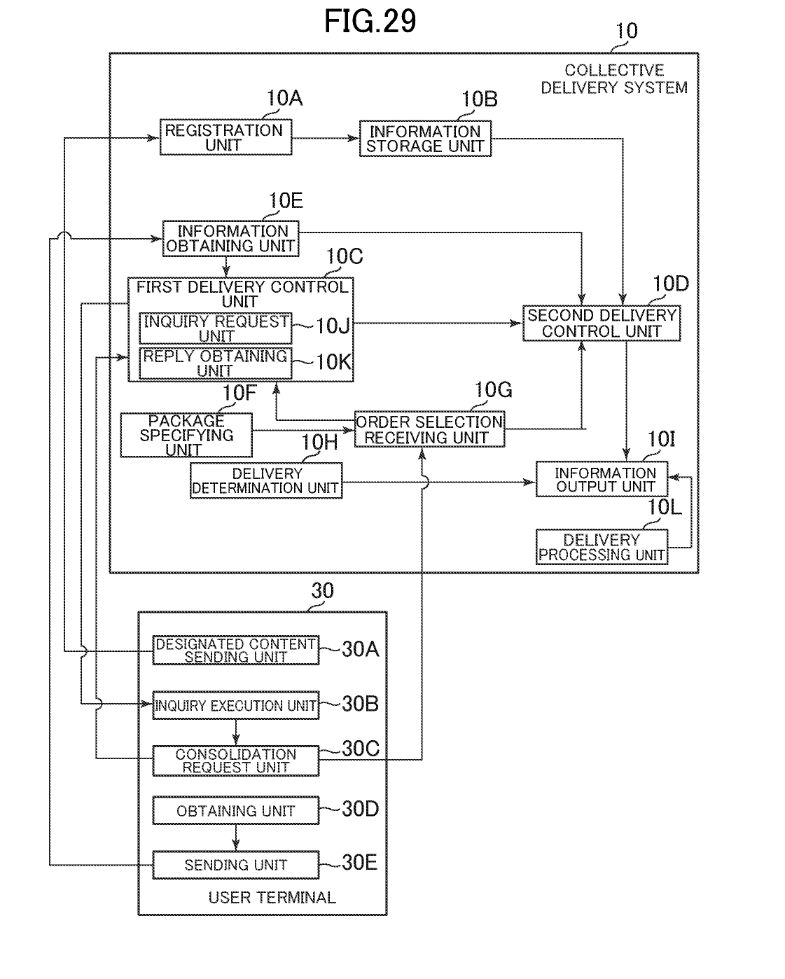

FIG. 29 is a function block diagram of a modified example. As shown in FIG. 29, in the modified example, an inquiry request unit 10J, a reply obtaining unit 10K, and a delivery processing unit 10L are further implemented in the collective delivery system 10, and an obtaining unit 30D and a sending unit 30E are implemented at the user terminal 30. The inquiry request unit 10J and the reply obtaining unit 10K are implemented mainly using the control unit 11 and the communication unit 13, while the delivery processing unit 10L is implemented mainly using the control unit 11. The obtaining unit 30D is implemented mainly using the control unit 31, and the sending unit 30E is implemented mainly using the control unit 31 and the communication unit 33.

(1) For example, timing at which a user designates collective delivery and a relationship between respective systems are not limited to the examples descried in the embodiments, and a variety of patterns are applicable, as will be described below. In each pattern, even though the delivery companies for respective packages at the time of shipment are different from each other, by setting the first delivery information by the first delivery control unit 10C and the second delivery information by the second delivery control unit 10D, it is possible to deliver the respective packages to a user by a single delivery company. Note that although a case in which a user orders an item for itself, as in the second embodiment, will be described below as an example for brevity of description, similar processing may be executed in a case as well in which a user orders an item for another user, as is in the first embodiment.

(1-1) Initially, although a case in which collective delivery is designated after an item is ordered has been described in the embodiments, collective delivery may be designated at the time of ordering an item. For example, when a user designates a delivery condition for a package relevant to an order, the first delivery control unit 10C executes processing for encouraging to set the delivery destination included in the first delivery information to be associated with the package to the holding center. This processing is processing for displaying at the user terminal 30 a screen for inquiring whether or not to set a delivery destination to the holding center.

In the modified example (1-1), the first delivery control unit 10C includes the inquiry request unit 10J and the reply obtaining unit 10K. In a case where the delivery destination decided on at the time of order by a user is the same as the delivery destination of an item having been ordered and the delivery companies for collecting these items from the respective shipping sources are different, the inquiry request unit 10J sends an inquiry to the user terminal 30 to inquire whether or not to consolidate deliveries of these items.

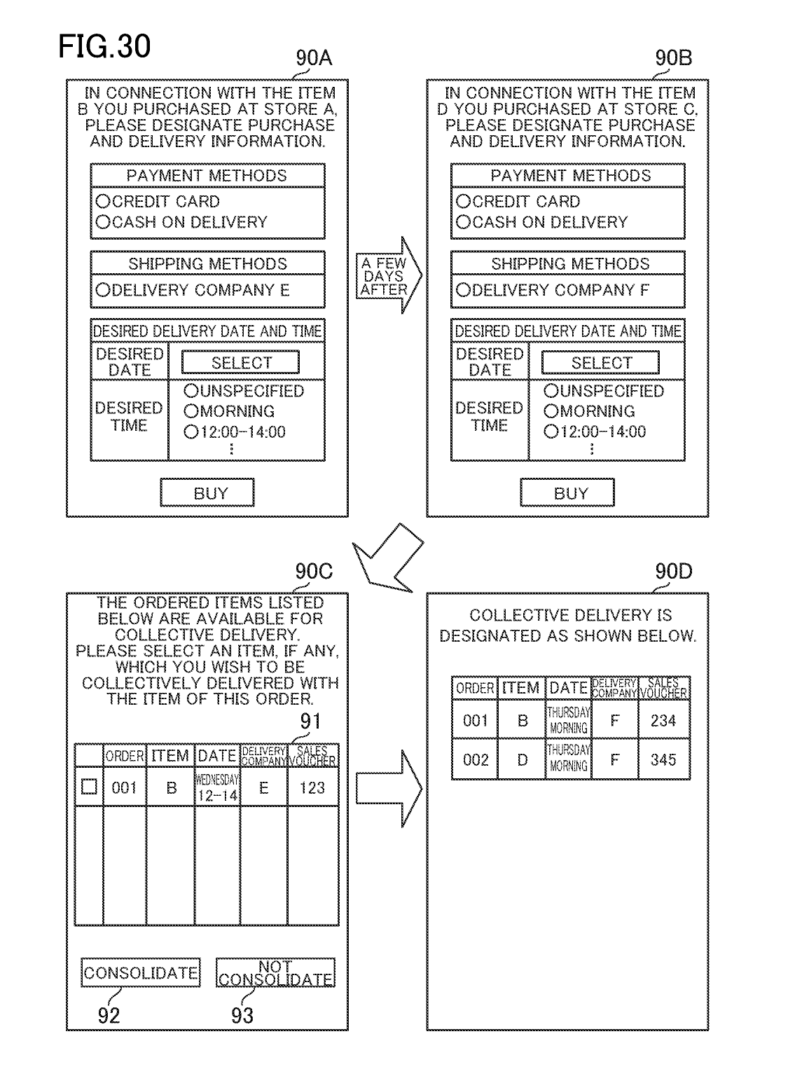

FIG. 30 shows shift of screens displayed when a user orders an item. As shown in FIG. 30, assume that a user orders an item at a store on an order screen 90A, and thereafter buys an item at a different store on an order screen 90B. In this case, orders available for collective delivery among orders made in the past are displayed as a list 91 (an order screen 90C). The list 91 is displayed through processing similar to that for displaying the list 83.

Then, the user selects at least one order from among those shown in the list 91, and selects a button 92 for collective delivery, whereby the item of the order selected and the item being currently ordered are designated as collective delivery targets. For example, when the user selects the button 92, the second delivery information to be associated with the current order and the order selected from the list 91 is generated, and the content thereof is displayed on an order screen 90D. Meanwhile, when the user selects a button 93, collective delivery is not made.

The reply obtaining unit 10K obtains a reply to the inquiry inputted at the user terminal 30. That is, the reply obtaining unit 10K obtains from the user terminal 30 whether the user has made an operation for consolidating deliveries (for example, selection of the button 92) or an operation for not consolidating deliveries (for example, selection of the button 93).

The first delivery control unit 10C and the second delivery control unit 10D in this modified example execute processing when having obtained a reply to the effect of consolidating deliveries. That is, when a reply to the effect of consolidating deliveries is obtained, the first delivery control unit 10C sets the first delivery information, and the second delivery control unit 10D sets the second delivery information. Meanwhile, when a reply to the effect of not consolidating deliveries is obtained, the first delivery control unit 10C does not set the first delivery information, and the second delivery control unit 10D does not set the second delivery information.

Specifically, when a user orders an item, the first delivery control unit 10C sets the first delivery information to be associated with the item so as to indicate that delivery should be made from the shipping source to the holding center by the delivery company decided on at the time of order. That is, as an item which a user is going to order does not yet have first delivery information associated therewith, the first delivery control unit 10C generates the first delivery information and associates with the item. Note that the processing for setting the first delivery information by changing the delivery destination indicated by the order time delivery information associated with an item having been ordered to the holding center is similar to the method described in the embodiments.

The second delivery control unit 10D generates the second delivery information and associates with an item which a user is going to order and an item having been ordered. That is, the second delivery control unit 10D associates the second delivery information with an item as well which a user is going to order.

According to the modified example (1-1), when a user orders an item, it is possible to have the user to select whether or not to consolidate deliveries of the item just ordered and of an item ordered in the past even though the delivery companies for collecting these items are different from each other. Further, it is possible to have the user to select an order for which delivery is consolidated from among orders made in the past.

(1-2) Also, for example, although a case in which an administrator of the collective delivery system 10 is the same as an administrator of the electronic commerce system 20 and these systems are integrated with each other has been described in the embodiments, the collective delivery system 10 and the electronic commerce system 20 may be different entities with different administrators. Below, as individual processing relevant to collective delivery of items is similar to that which has been described in the embodiments, only an outline of the processing will be shown and described.

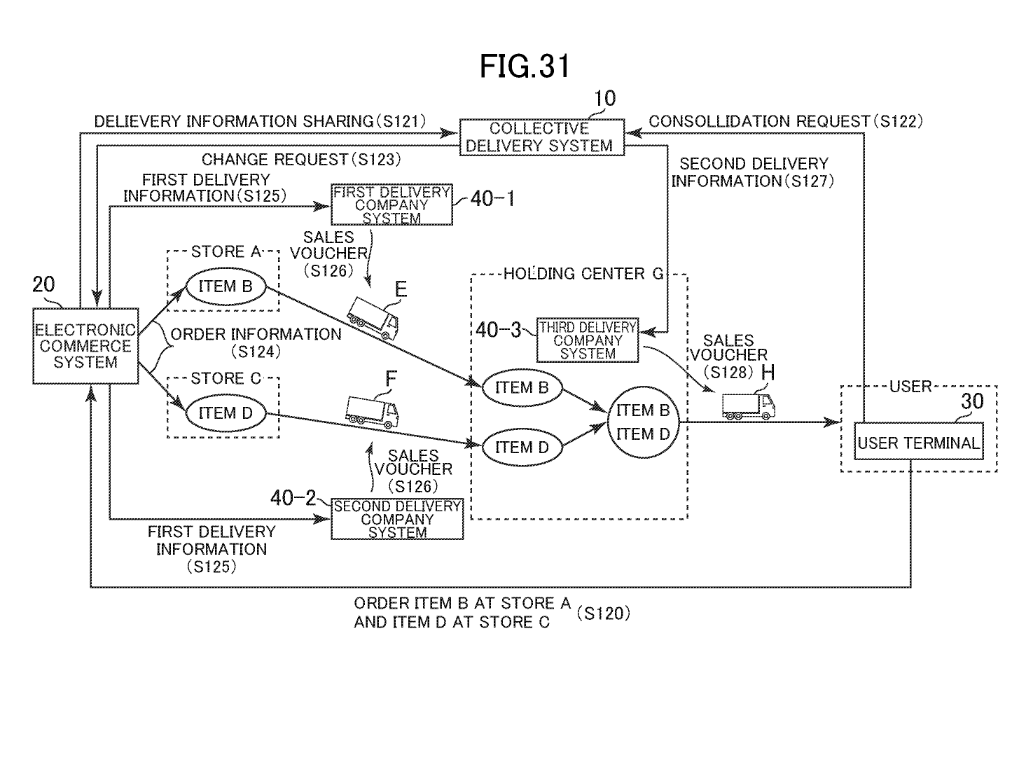

FIG. 31 explains an outline of processing executed in the modified example. Data is shared by the collective delivery system 10 and the electronic commerce system 20 via a network even though the collective delivery system 10 is separate from the electronic commerce system 20. As shown in FIG. 31, when a user orders an item at each store (S120), the electronic commerce system 20 generates order information and shares the delivery information included in the order information with the collective delivery system 10 (S121). When the user makes a consolidation request (S122), the collective delivery system 10 makes a change request for changing the delivery destination (S123).

The electronic commerce system 20 changes the delivery destination to the holding center, sends the order information to the respective stores (S124), and sends the first delivery information to the first delivery company system 40-1 and the second delivery company system 40-2 (S125). Based on the first delivery information, each of the first delivery company system 40-1 and the second delivery company system 40-2 prints a sales voucher, and the delivery companies collect items from the respective stores and deliver to the holding center (S126). When the collective delivery target packages are gathered in the holding center, the collective delivery system 10 generates the second delivery information (S127), the third delivery company system 40-3 prints a sales voucher based on the second delivery information, and the delivery company delivers those packages gathered in the holding center to the user (S128).

As described above, even though the collective delivery system 10 and the electronic commerce system 20 are separate entities, the collective delivery system 10 can set the first delivery information and the second delivery information through cooperation therebetween. Note that the collective delivery system 10 may manage the first delivery information and the second delivery information, and the electronic commerce system 20 may manage only the first delivery information.

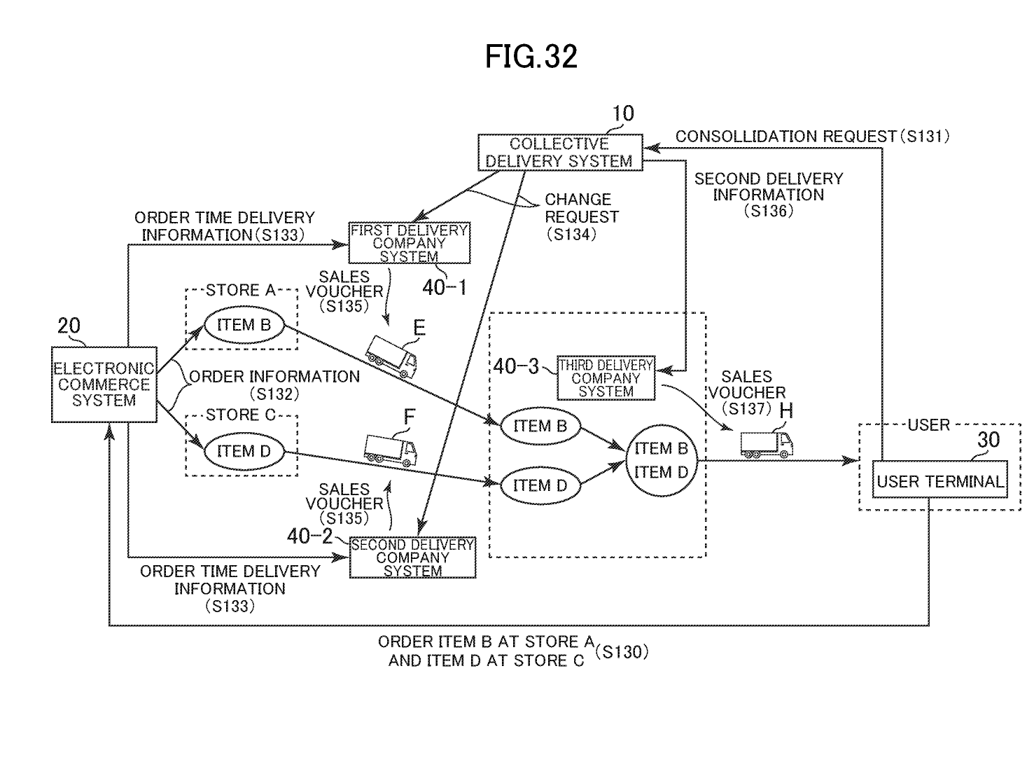

(1-3) Also, for example, when the collective delivery system 10 and the electronic commerce system 20 are separate entities, these systems may not necessarily cooperate with each other. FIG. 32 explains an outline of processing executed in a modified example. As shown in FIG. 32, when a user orders items at respective stores (S130), the electronic commerce system 20 generates order information and sends to the user terminal 30 by means of electronic mail etc. The user selects an order that makes a collective delivery target from among the order information items received, and sends a consolidation request to the collective delivery system 10 together with the order information (S131). Moreover, the electronic commerce system 20 sends the order information to the respective stores (S132), and sends the order time delivery information to the first delivery company system 40-1 and the second delivery company system 40-2 (S133). Note that the delivery destination indicated by the order time delivery information is the user yet.

In response to the consolidation request, the collective delivery system 10 sends a delivery destination change request to each of the first delivery company system 40-1 and the second delivery company system 40-2 (S134). Then, each of the first delivery company system 40-1 and the second delivery company system 40-2 prints a sales voucher based on the first delivery information generated by changing the delivery destination to the holding center, and the respective delivery companies collect items from the respective stores and deliver to the holding center (S135). Subsequent S136 and S137 are similar to S127 and S128. In a case where the collective delivery system 10 cooperates with the delivery company system 40, as described above, the collective delivery system 10 requests the delivery company system 40 to change the delivery destination.

In a case where the collective delivery system 10 obtains information on an order that is a collective delivery target from the user terminal 30, as described above, the storage unit 32 of the user terminal 30 stores information on an item having been ordered. That is, for example, when a user orders an item, the electronic commerce system 20 generates order information, and notifies the user terminal 30 of the content of the order information by means of a predetermined notice medium (for example, electronic mail). Therefore, the order ID, store information, user information, item information, and delivery information of the order made by the user are stored in the storage unit 32 of the user terminal 30.

Also, in this modified example, the obtaining unit 30D and the sending unit 30E are implemented. The obtaining unit 30D obtains information on packages for which deliveries should be consolidated stored in the storage unit 32 of the user terminal 30. For example, the obtaining unit 30D obtains respective information items (for example, the order ID, etc.) included in the order information notified by the electronic commerce system 20.

The sending unit 30E sends the information obtained by the obtaining unit 30D to the collective delivery system 10. For example, the sending unit 30E sends information for identifying a combination of orders that make collective delivery targets to the collective delivery system 10. This combination may be designated by a user, as in the embodiments.

With the above, even though the collective delivery system cannot obtain the order information from the electronic commerce system 20 or the delivery company system 40, the collective delivery system 10 can obtain the content of the order information from the user terminal 30. In particular, as the order information is automatically extracted and sent based on the data recorded in the user terminal 30, it is possible to save trouble for a user to input information concerning collective delivery one by one. Note that the collective delivery system 10 may obtain the order information on a collective delivery target from the first to third delivery company systems 40-1 to 40-3, rather than from the user terminal 30.

(1-4) Also, for example, the collective delivery system 10 may not cooperate with the delivery company system 40. In this case, as the collective delivery system 10 cannot make a change request at S134 in FIG. 32, the collective delivery system 10 may request the electronic commerce system 20 or the delivery company system 40 via the user terminal 30. Alternatively, the collective delivery system 10 may generate the first delivery information and the second delivery information, which are then sent to the electronic commerce system 20 and the first to third delivery company systems 40-1 to 40-3 through an operation by an operator.

(1-5) Also, for example, there may be two or more electronic commerce systems 20 available, for example. That is, each package to be delivered by a delivery company may be an item ordered by a user using any of the plurality of electronic commerce systems 20-k (k being a natural number, being one or two here but may be three or greater).

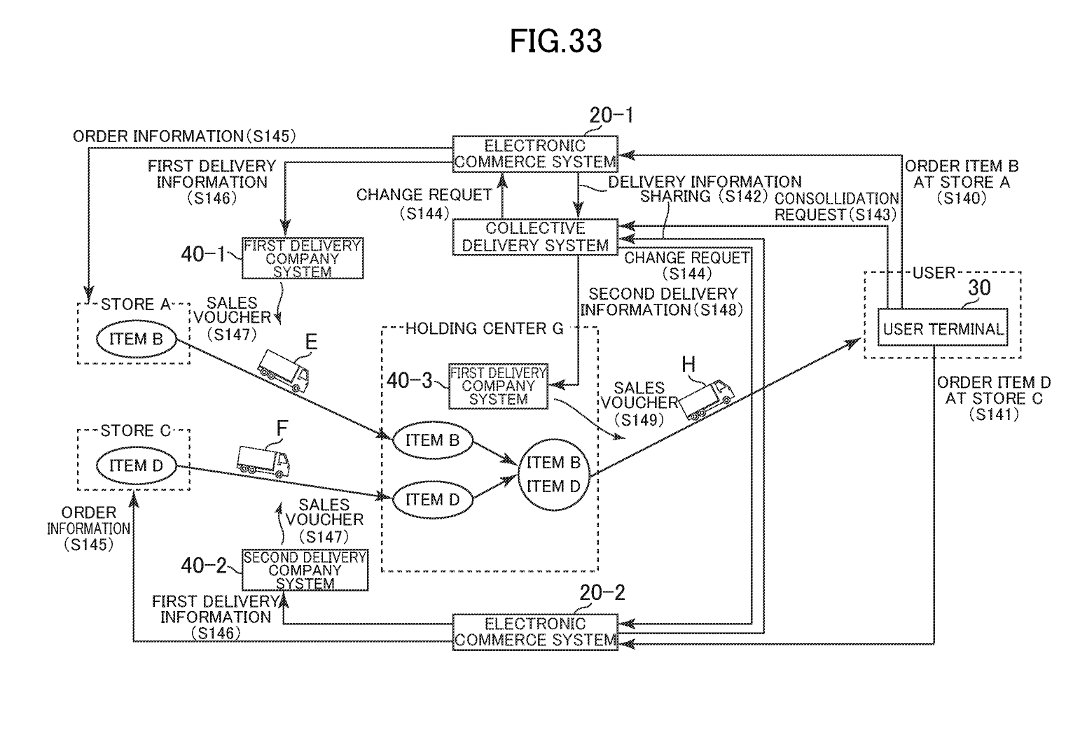

FIG. 33 explains an outline of processing executed in a modified example. As shown in FIG. 33, when a user orders an item at a store in a single electronic commerce system 20-1 (S140), and also an item at a store in a different electronic commerce system 20-2 (S141), the electronic commerce systems 20-1 and 20-2 each generate order information, and share the delivery information included in the respective order information items with the collective delivery system 10 (S142). When the user makes a consolidation request (S143), the collective delivery system 10 makes a change request to the electronic commerce systems 20-1 and 20-2 to change the delivery destinations included in the respective first delivery information items (S144).

Each of the electronic commerce systems 20-1 and 20-2 changes the delivery destination to the holding center, and sends the order information to the relevant store (S145) and further sends the first delivery information to the first delivery company system 40-1 or the second delivery company system 40-2 (S146). Each of the first delivery company system 40-1 and the second delivery company system 40-2 prints a sales voucher based on the first delivery information, and the respective delivery companies collect items from the respective stores and deliver to the holding center (S147). Subsequent S148 and S149 are similar to S127 and S128. As shown in FIG. 33, even when orders are made over a plurality of electronic commerce systems 20-1 and 20-2, it is possible to achieve collective delivery through processing similar to that in the embodiments when the collective delivery system 10 obtains the order information from the respective electronic commerce systems 20.

In this case, the first delivery control unit 10C can set the first delivery information to be associated with each of the packages ordered in the respective different electronic commerce systems 20-1 and 20-2. For example, the first delivery control unit 10C sends a change request to each of the electronic commerce systems 20-1 and 20-2 to change the delivery destination indicated by the first delivery information.

Also, for example, the second delivery control unit 10D sets the second delivery information to be associated with the packages ordered in the respective different electronic commerce systems 20-1 and 20-2. For example, the second delivery control unit 10D generates the second delivery information according to a method similar to that in the embodiments, and associates with the respective items ordered in the respective electronic commerce systems 20-1 and 20-2.

According to the modified example (1-5), even when a user has ordered items in a plurality of respective electronic commerce systems 20-1 and 20-2, it is possible to collectively deliver these items.

(1-6) Also, for example, the respective patterns in the above described modified examples (1-1) to (1-5) may be combined. That is, even when patterns of five respective conditions, namely, whether the consolidation instruction is made at or after the time of order, whether the collective delivery system 10 and the electronic commerce system 20 are integral or separate, whether the collective delivery system 10 and the electronic commerce system 20 cooperate with each other, whether the collective delivery system 10 and the first to third delivery company systems 40-1 to 40-3 cooperate with each other, and whether there are two or more electronic commerce systems 20 available, are combined, the collective delivery system 10 can set the first delivery information and the second delivery information to achieve collective delivery by applying the flow of processing described above.

(2) Also, for example, although a case in which a sales voucher number is issued for every order to generate the second delivery information has been described, only one second delivery information may be generated with respect to all items for collective delivery as substantial content of the second delivery information is the same. That is, the second delivery control unit 10D sets one common second delivery information with respect to respective packages. For example, the second delivery control unit 10D may issue a sales voucher number common to the respective orders for collective delivery, rather than issuing a sales voucher number for every order for collective delivery.

According to the modified example (2), by issuing a sales voucher number common to respective orders for collective delivery, it is possible to facilitate management of collective delivery.

(3) Also, for example, as there is a possibility that all collective delivery target packages have yet to be arrived in the holding center for any reason, such as whether, road condition, etc. even though a time for collective delivery has already arrived. In this case, collective delivery may be made with only packages arrived in the consolidation target storage area. This timing is, for example, shipping timing determined based on the designated delivery date and time indicated by the second delivery information (for example, timing prior to the designated delivery date and time indicated by the second delivery information by a predetermined period of time).

The delivery determination unit 10H in this modified example determines whether or not there is any package yet to be delivered to the holding center among the packages that are collective delivery targets. Specifically, with reference to the delivery status indicated by the first delivery information of each of the packages that are collective delivery targets, the delivery determination unit 10H determines whether or not there is any package yet to be delivered to the holding center.

Also, in the modified example (3), the delivery processing unit 10L is implemented. When it is determined that there is a package yet to be delivered to the holding center, the delivery processing unit 10L executes predetermined processing for notifying a single delivery company whether or not to make delivery with only the packages having been delivered to the holding center. Below, processing for inquiring a user whether or not to make delivery with only the packages having been delivered to the holding center and notifying a delivery company whether or not to make delivery with only those packages, depending on a reply from the user, will be described as an example. Note that the predetermined processing executed by the delivery processing unit 10L is not limited to the above described, and processing to be described later is also applicable.

When it is determined that there is a package yet to be delivered to the holding center, the inquiry request unit 10J in the modified example initially inquires of a user whether or not to make shipment with only the packages having been delivered to the holding center. Note that the inquiry request unit 10J may refer to the delivery status indicated by the first delivery information to specify a package having been delivered to the holding center, and notify a user of the package specified.

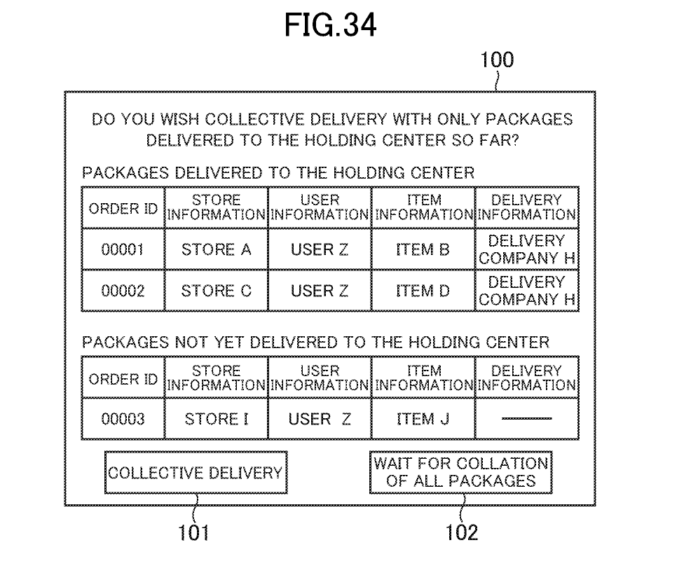

FIG. 34 shows one example of a screen for inquiring whether or not to make shipment with only packages having been delivered to the holding center. As shown in FIG. 34, a message for inquiring whether or not to make collective delivery with only packages having been delivered to the holding center is displayed on an inquiry screen 100. Specifically, information for identifying a package having been delivered to the holding center and information identifying a package yet to be delivered to the holding center are displayed on the inquiry screen 100 here.

By selecting a reply button 101, the user can reply to the effect that collective delivery will be made with only packages having been delivered to the holding center. Meanwhile, by selecting a reply button 102, the user can reply to the effect that collective delivery will not be made with only packages having been delivered to the holding center but be waited until all collective delivery target packages will have been arrived.

Based on the reply from the user in response to the inquiry, the delivery processing unit 10L notifies the delivery company whether or not to make delivery with only the packages having been delivered to the holding center. For example, the delivery processing unit 10L notifies by means of an image or sound to make delivery with only the packages having been delivered to the holding center. When a reply to the effect that collective delivery will be made with only the packages having been delivered to the holding center is obtained, the delivery processing unit 10L notifies the delivery company of that effect. Meanwhile, when a reply to the effect that collective delivery will not be made with only the packages having been delivered to the holding center is obtained, the delivery processing unit 10L waits until all packages will have been arrived. Note that in this case, the delivery processing unit 10L may delay the designated delivery date and time indicated by the second delivery information.

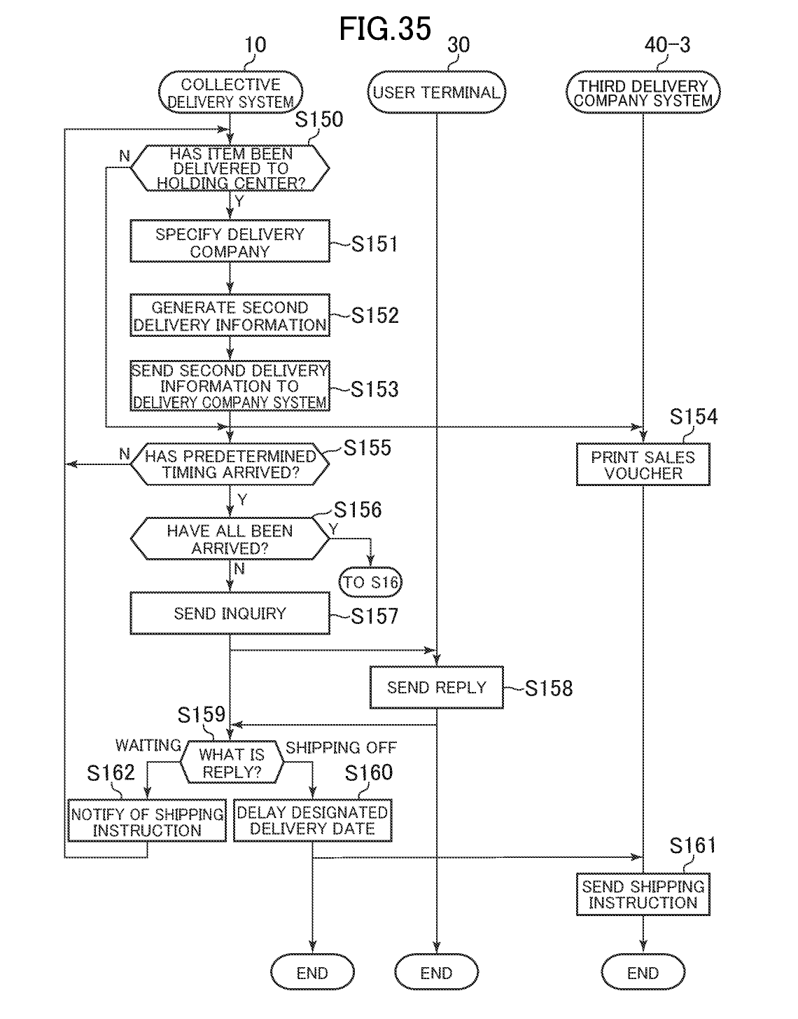

FIG. 35 shows processing executed in the modified example (3). Note that for execution of the processing shown in FIG. 35, assume that the processing at S101 to S109 has been executed. As shown in FIG. 35, the processing at S150 to S154 is similar to that at S110 to S114, respectively. In the collective delivery system 10, the control unit 11 determines whether or not predetermined timing corresponding to the designated delivery date and time indicated by the second delivery information has arrived (S155).

When it is determined that the predetermined timing has arrived (S155; Y), the control unit 11 determines whether or not all collective delivery target packages have been arrived (S156). A method for the determination at S156 is similar to that at S115. When it is determined that all collective delivery target packages have been arrived (S156; Y), processing at S116 and S117 is executed.

Meanwhile, when it is determined that there is a package yet to be arrived (S156; N), the control unit 11 sends to the user terminal 30 an inquiry as to whether or not to make shipment with only packages having arrived at the holding center (S157). At S157, the control unit 11 generates data for displaying the inquiry screen 100 at the user terminal 30, and sends to the user terminal 30. For example, with reference to the delivery status indicated by the first delivery information of each of the collective delivery target packages, the control unit 11 specifies a package having arrived at the holding center and a package having yet to arrive at the holding center. Then, the control unit 11 generates and sends data for the inquiry screen 100 for distinctively displaying these packages.

At the user terminal 30, upon receipt of the inquiry, the control unit 31 displays the inquiry screen 100 to send a reply from the user (S158). At S158, the control unit 31 sends information for identifying a reply button 101 or 102 selected by the user to the collective delivery system 10.

In the collective delivery system 10, upon receipt of the reply from the user, the control unit 11 refers to the reply (S159). In the case of a reply to the effect that shipment will be made (S159; shipment), the control unit 11 sends a shipping instruction to make shipment with only the packages having arrived at the holding center to the third delivery company system 40-3 (S160). The shipping instruction at S160 includes, for example, information for identifying a combination of packages to be shipped (for example, the sales voucher number, etc., included in the second delivery information).

The third delivery company system 40-3 notifies a delivery company to make shipment with only the packages having arrived at the holding center (S161). The notice at S161 is made by displaying a predetermined screen for identifying a package to be shipped, printing an image for identifying a package to be shipped, or outputting sound for identifying a package to be shipped, similar to the notice at S117. In this case, the delivery company will make delivery with only the packages present in the consolidation target storage area in the holding center.

Meanwhile, upon receipt of a reply to the effect of waiting (S159; waiting), the control unit 11 delays the designated delivery date and time indicated by the second delivery information of each package (S162), and returns to the processing at S150. In this case, arrival of an undelivered package is waited for until arrival of the next predetermined timing. Alternatively, collation of all collective delivery target packages may be waited for without executing the processing at S162, that is, without delaying the designated delivery date and time, so as to avoid re-inquiry to a user.

According to the modified example (3), it is possible to have a user to select whether to make shipment with only packages arrived in the holding center or to wait for collation of all package even when all collective delivery target packages have not yet been arrived in the holding center. For example, although there is a possibility that delivery is not made as scheduled in collective delivery according to the collective delivery system 10 as different delivery companies deliver from respective stores to the holding center, it is possible to preferably cope with such a situation.

Note that the predetermined processing executed by the delivery processing unit 10L is not limited to the above described example. Other than the above, for example, the delivery processing unit 10L may instruct to make shipment with only packages having been delivered to the holding center without inquiring of a user. Further, a user may designate in advance whether or not to make shipment with only packages having been delivered to the holding center and the content designated may be stored in the information storage unit 10B. The delivery processing unit 10L instructs to make shipment when it is designated to the effect that shipment will be made.

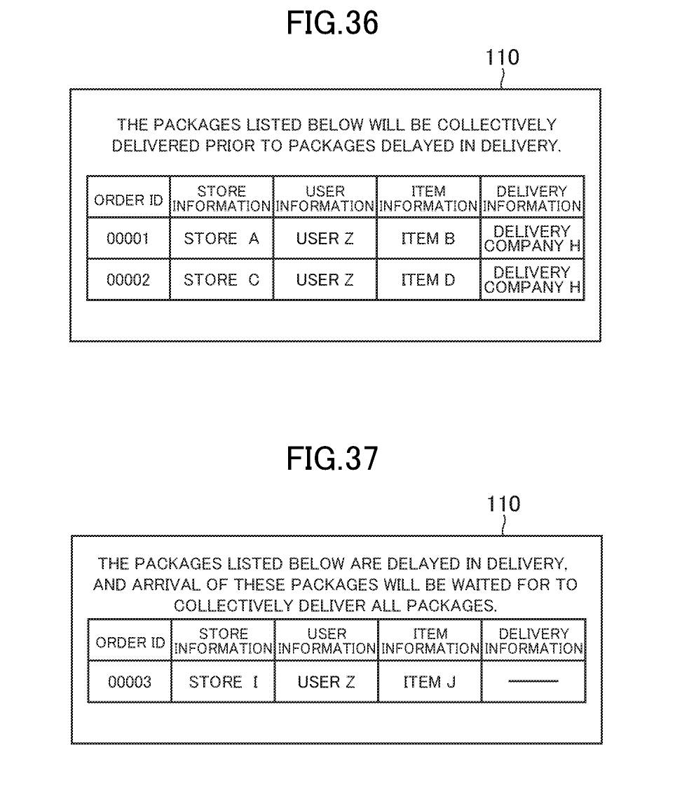

In this case, the delivery processing unit 10L may notify the user that shipment will be made with only the packages having been delivered to the holding center. FIG. 36 shows one example of a screen for notifying that shipment will be made with only the packages having been delivered to the holding center. As shown in FIG. 36, on a notice screen 110, a message to the effect that collective delivery will be made with only the packages having been delivered to the holding center is displayed. Also, on the notice screen 110, information for identifying the package and the second delivery information may be displayed.

Also, for example, the delivery processing unit 10L may instruct to wait until collation of all packages for collective delivery, rather than making shipment with only packages having been delivered to the holding center, without inquiring of a user. For example, when a user has designated in advance that shipment would not be made with only packages having been delivered to the holding center, the delivery processing unit 10L may execute this processing.

In this case, the delivery processing unit 10L may notify the user that shipment will not be made with only the packages having been delivered to the holding center. FIG. 37 shows one example of the notice screen. As shown in FIG. 37, on the notice screen 110, a message to the effect that collective delivery will be detained until all packages will have been arrived in the holding center. Also, the notice screen 110 may display information for identifying a package yet to be delivered to the holding center and the first delivery information of the package. Further, once all packages are thereafter arrived in the holding center, the delivery processing unit 10L may notify the user that collective delivery will be made.

(4) Also, for example, although a case in which a user designates and registers in advance its desired date and time and a delivery company for collective delivery has been described in the embodiments, a desired date and time and the delivery company may be designated at the time of requesting consolidation or ordering an item.

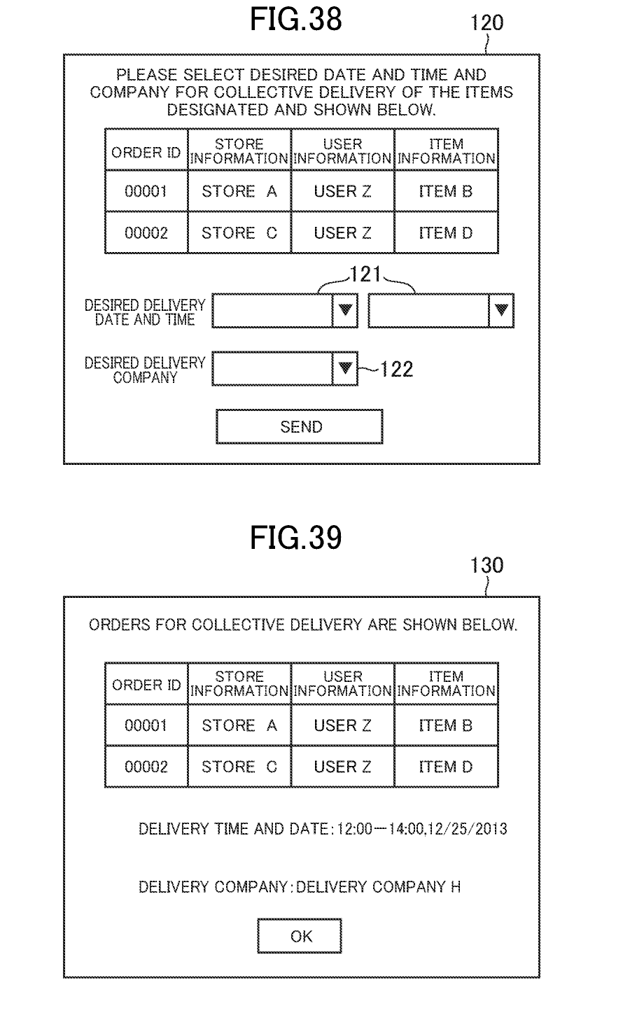

FIG. 38 shows one example of a screen displayed at the time of requesting consolidation or ordering an item. As shown in FIG. 38, an input form 121 for a user to designate its desired date and time for collective delivery and an input form 122 for a user to designate its desired delivery company to make collective delivery may be shown on an inquiry screen 120. In this case, assume that the date and time and delivery company designated by the user are stored in the information storage unit 10B so as to be associated with an order that is a collective delivery target. With reference to the content stored, the second delivery control unit 10D sets the second delivery information based on the date and time and delivery company designated by the user. Further, it may be arranged such that it is possible to confirm the delivery date and time and a delivery company designated by the user on the inquiry screen 120 after consolidation is requested.

FIG. 39 shows one example of a screen for confirming the delivery date and time and delivery company after consolidation is requested. As shown in FIG. 39, the delivery date and time and delivery company designated by a user on the inquiry screen 120 are shown on the confirmation screen 130. For example, when a user designates a collective delivery ID which the user wishes to confirm at the user terminal 30, the collective delivery system 10 displays the confirmation screen 130, based on the order information including the collective delivery ID designated.

Also, although it has been described in the above that the order time delivery information and the first delivery information are separate data, these data may be integral. That is, the first delivery control unit 10C may overwrite the delivery destination included in the order time delivery information to make the data subjected to overwrite as the first delivery information.

Also, data indicating an association between a delivery company and a holding center may be stored in the information storage unit 10B. For example, in a case where a holding center is available for every delivery company for collective delivery to a user, the first delivery control unit 10C sets the holding center associated with a delivery company that should make collective delivery as the delivery destination indicated by the first delivery information, and the second delivery control unit 10D sets that holding center as the shipping source indicated by the second delivery information.

Also, for example, a sales voucher printed based on the first delivery information may show only a bar code that identifies a sales voucher number as a receiver of a package to be delivered based on the sales voucher is not a user (that is, this is information seen only by a delivery company). Also, in delivering packages gathered in the holding center to a user, the packages may be packed into one package to be delivered or delivered separately at one time. Further, although a case in which two packages are collectively delivered has been mainly described as an example, three or more packages may be collectively delivered.

Also, for example, the electronic commerce system 20 and the first to third delivery company systems 40-1 to 40-3 may be integrated with the collective delivery system 10. Further, the functions other than the first delivery control unit 10C and the second delivery control unit 10D in the collective delivery system 10 may be omitted. In this case, the respective functions omitted may be implemented by other systems connected to the collective delivery system 10.

Also, for example, although the above description has been made referring as an example to the case of delivery of an item ordered by a user for itself or another user, as the collective delivery system according to the present invention is applicable to any case in which delivery companies are different when a plurality of packages are delivered to a single delivery destination, the above described example is not limiting. Other than the above, for example, the collective delivery system according to the present invention is applicable to a case in which an item knocked down by a user in an auction is delivered (that is, an item is collected from a user and delivered to another user (C to C)) and also to a case in which a plurality of senders send packages to a user, etc.

Although a case in which deliveries of items are consolidated has been described in the above, it may be arranged so as to allow a user to dare to designate not to consolidate deliveries on the premise that it is possible to consolidate deliveries. Further, with reference to an item master DB, consolidation processing may not be executed with respect to an item that is set not available for consolidation.

The invention claimed is:

1. A collective delivery system comprising at least one processor, wherein the at least one processor:
obtains a predetermined single delivery destination designated by a user who receives packages;
sets, if a plurality of packages collected from one or more shipping sources by a plurality of different delivery companies are delivered to the single delivery destination, first delivery information to be associated with each of the plurality of packages such that each of the plurality of different delivery companies delivers from a shipping source thereof to a predetermined place different from the single delivery destination;
sets second delivery information to be associated with each of the plurality of packages such that a single delivery company collectively delivers from the predetermined place to the single delivery destination; and
changes a delivery destination included in the first delivery information from the single delivery destination to the predetermined place.

2. The collective delivery system according to claim 1, wherein the at least one processor:
specifies a package that is set so as to be delivered from the shipping source to the single delivery destination;
receives selection of a package to be collectively delivered from among the specified packages; and
changes a delivery destination associated with the selected package.

3. The collective delivery system according to claim 1, wherein the at least one processor sets single second delivery information common to the plurality of packages.

4. The collective delivery system according to claim 1, wherein the at least one processor:
registers information indicating a time designated by a user associated with the single delivery destination in a storage; and
sets the second delivery information to be associated with each of the plurality of packages such that delivery is made at a time determined based on the information registered.

5. The collective delivery system according to claim 1, wherein the at least one processor sets the first delivery information to be associated with each of the plurality of packages such that arrival dates and times at which each of the plurality of packages arrives at the predetermined place match with each other.

6. The collective delivery system according to claim 1, wherein the at least one processor:
determines whether or not each of the plurality of packages has been delivered to the predetermined place; and
outputs, if it is determined that each of the plurality of packages has been delivered to the predetermined place, information for managing as a collective delivery target.

7. The collective delivery system according to claim 1, wherein the at least one processor:
determines whether or not there is a non-delivered package that is not yet delivered to the predetermined place among the plurality of packages; and
executes predetermined processing, if it is determined that there is the non-delivered package, for notifying of the single delivery company whether or not to make delivery with only delivered packages having been delivered to the predetermined place.

8. The non-transitory computer-readable information storage medium having stored thereon a program for causing a user terminal connected so as to be able to send and receive data with respect to the collective delivery system according to claim 1 to:
obtain information concerning a package to be collectively delivered stored in a storage of the user terminal; and
send the information obtained to the collective delivery system.

9. A non-transitory computer-readable information storage medium having stored thereon a program for causing a computer to:
obtain a predetermined single delivery destination designated by a user who receives packages;
set, if a plurality of packages collected from one or more shipping sources by a plurality of different delivery companies are delivered to the single delivery destination, first delivery information to be associated with each of the plurality of packages such that each of the plurality of different delivery companies delivers from a shipping source thereof to a predetermined place different from the single delivery destination;
set second delivery information to be associated with each of the plurality of packages such that a single delivery company collectively delivers from the predetermined place to the single delivery destination; and
change a delivery destination included in the first delivery information from the single delivery destination to the predetermined place.

10. A collective delivery method comprising:
obtaining a predetermined single delivery destination designated by a user who receives packages;
setting, if a plurality of packages collected from one or more shipping sources by a plurality of different delivery companies are delivered to the single delivery destination, first delivery information to be associated with each of the plurality of packages such that each of the plurality of different delivery companies delivers from a shipping source thereof to a predetermined place different from the single delivery destination;
setting second delivery information to be associated with each of the plurality of packages such that a single delivery company collectively delivers from the predetermined place to the single delivery destination; and
changing a delivery destination included in the first delivery information from the single delivery destination to the predetermined place.

11. The collective delivery system according to claim 1, wherein:
each of the plurality of packages is delivered based on a designation by a user who is different from the user who receives the packages, and
the at least one processor:
determines whether or not the delivery destination included in the first delivery information and the single delivery destination are the same; and
changes the delivery destination included in the first delivery information if the delivery destination included in the first delivery information and the single delivery destination are the same.
